(19) United States
(12) Patent Application Publication
(10) Pub. No.: US 2004/0122661 A1
(43) Pub. Date: Jun. 24, 2004

(54) Method, system, and computer program product for storing, managing and using knowledge expressible as, and organized in accordance with, a natural language

(75) Inventors: Lowell B. Hawkinson, Belmont, MA (US); Timothy A. Anderson, Sudbury, MA (US)

Correspondence Address: HALE AND DORR, LLP, 60 STATE STREET, BOSTON, MA, 02109

(73) Assignee: Gensym Corporation, Burlington, MA

(21) Appl. No.: 10/627,799

(22) Filed: Jul. 25, 2003

Related U.S. Application Data
(60) Provisional application No. 60/436,297, filed on Dec. 23, 2002.
(60) Provisional application No. 60/448,008, filed on Feb. 18, 2003.
(60) Provisional application No. 60/469,695, filed on May 12, 2003.

(51) Int. Cl. G06F 17/21

(52) U.S. Cl. 704/10

(57) ABSTRACT

A method, system, and computer program product for storing and managing a knowledge profile are described. The knowledge is stored in knowledge units representative of unconstrained natural language (NL). Any given knowledge unit is associatable with at least one other knowledge unit with the given knowledge unit being a context knowledge unit, and the at least one other knowledge unit being a detail knowledge unit of the associated context knowledge unit, and such that every given context knowledge unit that has at least one associated detail knowledge unit satisfies a NL relationship there-between that corresponds to one of the NL-expressible forms of the NL word “have”. The profile includes a core set of knowledge units for a core vocabulary of words, at least some of which are associated with knowledge units to provide a basic meaning of the associated words. The profile further includes a core set of knowledge units for core processing and core parsing NL-expressible knowledge. The knowledge units are arranged in accordance with a predefined structure that reflects context-detail relationships and that is dynamically extensible to include other knowledge units during run-time; and the placement and relationships of knowledge units within the predefined structure further reflect semantic interpretations of the knowledge units and support algorithmic reasoning about the knowledge in the profile. In certain embodiments, the profile includes NL class structures to form knowledge units to represent NL words and phrases, and the profile includes NL word class structures to form knowledge units to represent NL words.

### CROSS REFERENCE OF RELATED APPLICATIONS

This application claims priority under §119(e) to the following related provisional patent applications:

Personal Activity Manager (PAM) (U.S. Provisional Patent Apl. Ser. No. 60/436,297, filed Dec. 23, 2002);

Personal Activity Manager (PAM) (U.S. Provisional Patent Apl. Ser. No. 60/448,008, filed Feb. 18, 2003); and

Method, System, and Computer Prograrn Product for Storing, Managing and Using Knowledge Expressible as, and Organized in Accordance with, Natural Language (U.S. Provisional Patent Apl. Ser. No. 60/469,695, filed May 12, 2003).

### BACKGROUND

1. Field of the Invention

This invention relates generally to maintaining, storing and using knowledge and, more specifically, to systems and methods that do so with natural language knowledge.

2. Discussion of Related Art

It is commonplace for people to manage their lives with the help of computers: our schedules and address books are kept on personal digital assistants (PDAs); our personal finances are tracked and managed using a combination of the Internet and software on home computers; our photo albums, music collections, and genealogical data are all stored and managed using computers. The software used to accomplish these tasks is generally rather narrowly focused and inflexible: although a PDA can store and display my schedule and contacts, its notion of time is limited to days and hours, rather than allowing an expression such as “the week after I get back from vacation”; its notion of relationships is limited to what can be declared in a fixed database schema. As a result of increases in processing power and storage capacity, it is feasible to build systems with more understanding of general knowledge, more ability to reason about events, relationships, and objects, and a natural language interface.

Building such systems requires, first, the ability to represent a wide range of knowledge—about the world at large, about a natural language such as English, and about a specific user's possessions, relationships, tasks, and priorities—in a manner that makes it accessible for automated reasoning, and that allows the knowledge base to grow in directions not anticipated by the software designers. The general problem of knowledge representation using computers has been a subject of active research for more than forty years, including contemporary efforts such as: Princeton's WordNet project, a static database representing a great deal of information about English; the Cyc knowledge base, a very large knowledge base to facilitate common sense reasoning; and the World Wide Web Consortium's Semantic Web effort, which provides a way for content on the Internet to carry information about its meaning, rather than simply how to display it.

Efforts to allow computers to understand natural language input (and to generate natural language output) have also been the subject of active research for several decades. These are often tied to the similar but much more difficult problem of speech understanding, where researchers have learned the importance of restricting the conversational domain in order to allow the computer to use a subset of its knowledge. The software used to parse written or spoken English is outside the scope of this invention, but the invention uses such software, for example the Link Grammar Parser, as a component.

### SUMMARY

The invention is a method, system, and computer program product for storing and managing a knowledge profile.

According to one aspect of the invention, the knowledge is stored in knowledge units representative of unconstrained natural language (NL). Any given knowledge unit is associatable with at least one other knowledge unit with the given knowledge unit being a context knowledge unit, and the at least one other knowledge unit being a detail knowledge unit of the associated context knowledge unit, and such that every given context knowledge unit that has at least one associated detail knowledge unit satisfies a NL relationship there-between that corresponds to one of the NL-expressible forms of the NL word “have”. The profile includes a core set of knowledge units for a core vocabulary of words, at least some of which are associated with knowledge units to provide a basic meaning of the associated words. The profile further includes a core set of knowledge units for core processing and core parsing NL-expressible knowledge. The knowledge units are arranged in accordance with a predefined structure that reflects context-detail relationships and that is dynamically extensible to include other knowledge units during run-time; and the placement and relationships of knowledge units within the predefined structure further reflect semantic interpretations of the knowledge units and support algorithmic reasoning about the knowledge in the profile.

According to another aspect of the invention, the profile includes NL class structures to form knowledge units to represent NL words and phrases.

According to another aspect of the invention, the profile includes NL word class structures to form knowledge units to represent NL words.

According to another aspect of the invention, the NL word class structures have associated values, and wherein the associated values of the word class structures are spellings of the word corresponding to the NL word class structure.

According to another aspect of the invention, the profile includes qualified word class structures to form knowledge units to represent NL phrases.

According to another aspect of the invention, to form knowledge units to represent NL phrases, the profile includes qualified word class structures and NL word class structures, and wherein a NL word class is used to represent a head word of the NL phrase and wherein qualified word class structures are used to represent a series of qualifiers of the head word in accordance with the NL phrase expression of the qualifiers.

According to another aspect of the invention, the knowledge units to represent NL phrases include qualifier class structures to represent a role of the qualifiers of the qualified word class.

According to another aspect of the invention, the combination of the role and the NL word class used to represent a head word represent semantics of the NL phrase.

According to another aspect of the invention, the qualified word class structures may be chained to represent arbitrary NL phrases.

According to another aspect of the invention, the profile includes detail structures to represent instances associated with a corresponding class structure and wherein the class structure represents a kind of thing the detail represents an instance of.

According to another aspect of the invention logic transforms a knowledge unit that represents a NL phrase and comprised of a class structure for a head word and qualified class structures for a series of associated qualifiers of the head word into a semantically equivalent knowledge unit comprised of a detail structure that represents an instance of the head word NL class structure wherein said instance is specified by associated details with semantic equivalence of the associated qualifiers.

According to another aspect of the invention, logic transforms a detail structure that represents an instance of a head word NL class structure, wherein said instance is specified by associated details, into a semantically equivalent knowledge unit that represents a NL phrase and comprised of a class structure for a head word of the phrase and qualified class structures for a series of associated qualifiers of the head word with semantic equivalence of the associated details of the instance.

According to another aspect of the invention, the profile is organized in accordance with predetermined rules and wherein a context knowledge unit includes a specification of detail knowledge units associated therewith and wherein the specification of detail knowledge units is canonically ordered in accordance with the predetermined rules.

According to another aspect of the invention, the NL class structures are arranged in accordance with a specified class hierarchy having NL subclasses and NL superclasses, and wherein each NL class has an associated class ID, and wherein class structures are assigned class IDs in accordance with the predetermined rules, and wherein the NL class structures of the profile are canonically ordered

According to another aspect of the invention, each class structure of a specified set of NL class structures corresponding to invertible NL relationships has an inverse relation detail specified by a class structure representing the inverse relation; and the medium includes logic that detects if an instance detail is being specified with a relationship detail, the relation for which is in the specified set, and that automatically creates an inverse relationship detail for the instance corresponding to the relationship detail, the inverse relationship detail specifying the context detail.

According to another aspect of the invention, logic monitors relationship details and automatically manages said details and corresponding inverse relation details in response to changes of either.

According to another aspect of the invention, NL class structures have an associated knowledge unit specifying details of a typical instance of a NL class represented by the NL class structure, whereby detail structures of the profile may reference one of said NL class structures with an associated typical instance, and whereby reasoning logic may infer knowledge about the instance by considering the details specified by the typical instance details.

According to another aspect of the invention, NL class structures have an associated knowledge unit specifying details of a model instance of a NL class represented by the NL class structure, and wherein a model instance specifies important details as being necessary for automated management of any instances of the NL class.

According to another aspect of the invention, logic automatically manages instances that have specifications for important details.

According to another aspect of the invention, logic delegates management of a knowledge unit to an agent.

### BRIEF DESCRIPTION OF THE DRAWINGS

In the Drawing,

FIG. 1 is an illustration of an exemplary architecture of a preferred embodiment of the invention;

FIG. 2 is an illustration of an exemplary architecture of a preferred embodiment of the invention, depicting some elements of FIG. 1 in more detail;

FIG. 3 is a high-level depiction of the organization of a detail tree of certain embodiments of the invention;

FIGS. 4A-5E are depictions of exemplary structures according to certain embodiments of the invention;

FIG. 6 is an exemplary class tree according to certain embodiments of the invention;

FIG. 7 is a portion of an exemplary profile according to certain embodiments of the invention;

FIG. 8 is a flow chart describing exemplary parsing logic according to certain embodiments of the invention;

FIGS. 9-19 are exemplary portions of exemplary profiles according to certain embodiments of the invention;

FIGS. 20A-B are flowcharts describing the logic of certain embodiments for assigning class IDs; and

FIGS. 21-22 are exemplary portions of exemplary profiles according to certain embodiments of the invention.

### DETAILED DESCRIPTION

Preferred embodiments of the invention provide a knowledge base and framework that allow software to store, manipulate, and reason on a wide range of information and knowledge that is expressible in a Natural Language (NL), such as English. The knowledge base will store knowledge and information expressed by the client(s). (The knowledge base, though containing knowledge that may be expressed in Natural Language, does not necessarily need to store or manipulate information expressed as such; instead the knowledge may be stored and manipulated in various qualified or derivative forms.) The knowledge base is intended to represent knowledge, rather than simply data: as information is added, its placement and relationships reflect semantic interpretations of the information, and support reasoning about what is stored. For example, a database might contain a set of people, with references to their parents; a knowledge base would have enough understanding of family relationships to identify (and store) siblings, uncles, and cousins based on the available parent-child data.

Preferred embodiments provide a core set of knowledge, much of which is related to knowledge needed to express and parse basic and common NL expressions (e.g., core vocabulary, numbering conventions, etc.). This core set might be supplemented with other application-specific knowledge as well; for example, an application might be directed to personal activity management and there may be a supplemental core set of knowledge useful for such, e.g., knowledge related to common vocabulary and expressions used in scheduling activities. The knowledge base may be, and preferably is, extended by knowledge from the client, as provided to the system from the client in some direct, qualified, or derivative form of NL (more below).

In a certain sense, the knowledge base (at least the client extended part) is subjective to the client. That is, since different clients may have different ways of expressing knowledge about a given thing, the knowledge about a given thing is subjective to the client's NL expression of such. For example, for a given dog, one client may express knowledge of such by referring to the dog as a “big black dog;” another might refer to the dog as simply a “fat dog;” and another might refer to the dog as a “black dog that is large.” In each case, the knowledge base (for a respective client) would extend the knowledge base to include the knowledge expressed by the client. All would include knowledge about the dog, but each would have different knowledge that depending on the reasoning and algorithms may be thought of as synonymous or distinct. That is, it is conceivable that some reasoning logic might consider “big,” “large” and “fat” as synonymous for whatever reasoning was being applied (assuming that the knowledge base had knowledge indicating that such words could be considered synonymous). However, other reasoning logic might recognize distinctions. For example, “fat” doesn't necessarily mean “big;” it might be a fat instance of a small breed dog, making it a relatively big for that breed but in the aggregate a small dog, e.g., a fat Yorkshire terrier. If the reasoning logic needed clarification it could consult other knowledge about the dog (for example, perhaps there's a detail specifying the breed of dog) or might even include logic to query a user for further information.

Certain embodiments structure all knowledge as a potentially enormous number (e.g., millions) of relationships from a relatively small set of predefined relationships. At the highest level of abstraction, one may think of the relationships as context/detail relationships. Under this view, each detail has a context, and each context is a detail of a higher-level context (with a very minor exception, discussed below). The context is said to “have” the details in some sense of the many senses of the word “have;” e.g., “have as a part”, “have as an attribute”, “have as a possession”, “have as a relative or friend”, “have as an event”, “have as an activity”, “have as an agenda”, “have as an element”, etc.

The use of the quite abstract “have” relationship facilitates communication between the system and its users, who are likely to have very different models of reality. Effective communication in general requires abstraction, because it allows extraneous details to be ignored, and allows people's inevitably differing mental models to find some common ground. Tom says, “I have a house,” and Fred hears, “I own a building in which I live.” Tom didn't mean exactly that, because he rents the house, but both Tom and Fred are now talking about the place Tom lives, because the “have” relationship is broad enough to allow their differing interpretations to intersect, thus allowing them to communicate.

Some of the relationships may have more specific meanings than context/detail. For example, certain embodiments have instance/class relationships (as will be clear from the description herein, “instance” and “class” as used herein are distinct from similarly named constructs in object oriented programming). At a higher level one can see that a class is a context and has as details various instances (though these are not the only details of a class). In the software logic, the logic might maintain separate references for context and class to facilitate management and flexibility. In this way, logic may reason about a detail by considering its context and/or its class. This instance/class relationship is useful because reasoning logic, in attempting to reason about a specific instance, may find it useful to reason about knowledge about the class. For example, a given instance of a class “person” might not have much or any specified detail, but nonetheless under preferred embodiments logic may still reason on such an instance by consulting the class. The class might have a detail specifying a “typical instance” of a person, and the typical instance might specify typical height and weight ranges. The reasoning logic might be able to use such information very effectively (e.g., recommending a new desk chair for someone who complained of back aches) while at the same time recognizing (in logic) that the suggestion was premised on an assumption that the person was “typical”.

The knowledge base and/or associated logic further recognizes other relationships. For example, the knowledge base will treat phrases as a unit of knowledge. Using the example above, the knowledge base may include data structures to manifest (at least temporarily) that the client expressed knowledge “big black dog.” Preferred embodiments can recognize relationships within such phrases to identify, for example, that the phrase has a presumed key or head word (in this case “dog”) and that the other words in some way qualify such word. Various reasoning may then be performed on the phrase. For example, the logic can identify that the phrase is about a “dog” and that it is qualified as big and black. The logic can further reason about the roles of various qualifiers. For example, in this instance, the logic may reason that black is an expression of the dog's color and that “big” is an expression of the dog's size. Notice that in other contexts and phrases the idea of role may be important. The word “blue” might be an expression of color in one phrase and an expression of mood in another.

Preferred embodiments adopt English as the basis for the representation of knowledge. This allows a large knowledge base to be represented concisely, and relationships among different words, classes of things, and specific entities to be represented in a way that is natural, easy to understand, and easy for software to reason with. This is done not just because of the power of English for representing knowledge and reasoning, but also because of the power of English for communication, especially with human users of the application. In addition, this approach (and the use of NL, such as English) benefits developers by making the knowledge representations they compute with and the reasoning thereon more understandable.

Classes, as used in the preferred embodiment, are the representations of words and phrases in a natural language such as English. The structures used to represent them preserve, within the limits of the system's ability to parse some natural language, both the words used to express the concept and the relationships described by the phrase. This permits reasoning to take place based on what the class represents, rather than simply on its methods and parent classes. As will be discussed below, a class can be named by a phrase: “all the dogs in the neighborhood” is a perfectly good class name. Its representation permits the system to identify, based on the phrase, what the phrase is referring to (a collection of dogs), a location for them (the neighborhood), and which ones (all of them). Reasoning can be performed based both on the details of the class, as mentioned, and on its relationships to other classes (the class “dog” is a subclass of “mammal,” which allows reasoning to apply whatever information it has about that class).

Conventional databases generally store information as unstructured text, or based on a carefully defined and seldom changed database schema, which specifies the kinds of objects that are represented, the data fields associated with each kind of object, and the relationships among them. Thus, the schema for a company's employee database would define the kinds of objects: employees, departments, and so on; a fixed set of relationships among those objects, such as manager/subordinate; and the data fields associated with each kind of object, such as employee ID, supervisor and salary. Data must be added to the database in conformance with the schema that was defined for it. Adding a new kind of object, or even new fields or relationship types to existing objects, requires a schema change and associated reprogramming—without the reprogramming, the new information, even if it is accessible, has no meaning.

The system of the present invention stores whatever the user can express in unconstrained natural language that the system can understand—that is, it is not constrained by a predefined database definition, nor by the design of the system. Rather, limits are imposed by the system's ability to understand natural language, which is subject to constant improvement as research progresses, and by its existing vocabulary, which can be enhanced in many ways, including by the user. There is no schema. The kinds of objects that can be stored, the data associated with them, and their relationships are not predefined: were employee data being stored, there might be some employee “records” that have “friend” information, some that have “best friend” information, some that have only basic information, and some that have nothing more than the employee's name.

Further, because the details associated with a particular employee are identified by classes whose names are natural language words or phrases, it is possible for the system to reason about them. A field whose class is “employee ID,” or “best friend,” has a meaning as well as a name, and provides at least the opportunity for the system to make deductions based on that meaning, even if there is no code in the system specifically designed to deal with it. That is, once the basic concept “friend” has been understood at some level (even if the system knows only that it's a relationship between people), it can reason usefully about a class “best friend” without additional programming. Although reprogramming might optimize the usage of new information, the system will, if it can parse the class name, understand it well enough to use it.

Exemplary Architecture

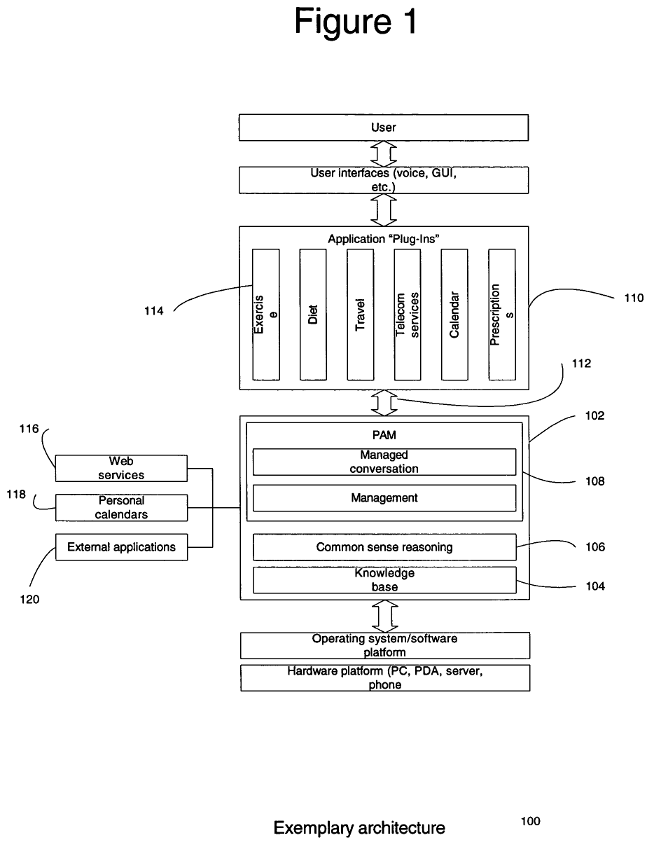

FIG. 1 illustrates exemplary software architectures according to certain embodiments of the invention. The exemplary architecture 100 includes a knowledge base 104, common sense reasoning logic 106 and, in this instance, a higher-level application such as personal activity management logic (PAM) 108. The knowledge base 104, common sense reasoning logic 106, and PAM 108 may be organized and packaged as a computer program product 102, and it may be architected to operate with other software, such as plug-ins 110, for example via predefined, exposed interfaces 112. The plug-ins may provide higher-level functionality or domain-specific applications, utilizing the lower-level components 104-108. The plug-in examples shown, such as Exercise 114, are examples only; the invention's use is not restricted to those areas. (Analogously, a computer program product may be arranged to contain only knowledge base 104 or to contain the knowledge base 104 combined with common sense reasoning logic 106. In such analogous cases, corresponding interfaces and specified behavior may be exposed for other software to utilize.)

As outlined above and described in more detail below, the knowledge base 104 of preferred embodiments is organized as a profile. The profile provides a consistent, yet flexible structure for storing and manipulating the broad range of knowledge (expressible in natural language) required to support common-sense reasoning about everyday actions.

Common sense reasoning logic 106 of certain embodiments includes a specified set of reasoning domains (e.g., time, location) and operations (ordering times, determining containment, respectively). The inventors envision that the common sense reasoning logic (and the procedure language) may be NL-based, though for purposes of this invention such is not necessary. Though the figure, to some, might suggest at first glance that the knowledge base 104 is visible only via the CSR 106, preferred embodiments provide direct visibility of the knowledge base 104 to higher-level applications 108, and through the interfaces 112 to plug-in applications such as 114.

Some embodiments provide access from the software product 102 to external facilities such as web services 116, personal calendars 118, and external applications 120. An application plug-in designed to manage travel arrangements might require such access in order to make flight reservations, for example.

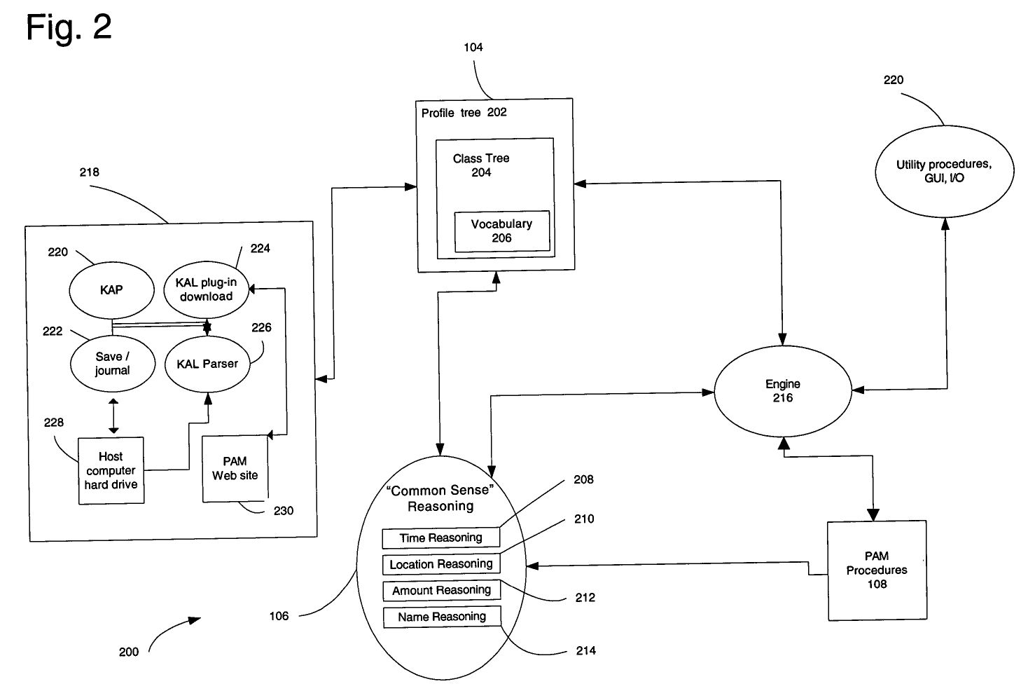

FIG. 2 shows a more detailed depiction of the architecture according to certain embodiments of the invention. The architecture is preferably implemented in software logic operating on a computer or other programmable device, such as a PDA, cell phone, etc. (assuming the platform has sufficient processing power and memory). The platform preferably includes logic and mechanisms to interact with storage as required and to communicate with other entities, including for example communication via the Internet.

The architecture 200 includes knowledge base 104, common sense reasoning logic 106 and, in this example, a higher-level application (PAM) 108. It also includes an engine 216, KAP/KAL logic 218, and other client and developer utilities 220, not important for this invention.

The knowledge base 104 includes a profile tree 202. A subset of the profile is a class tree 204 (more below). A subset of the class tree information is vocabulary details 206. As will be explained below, the profile tree preferably includes a core set of knowledge. This will include a core set of vocabulary details (e.g., common English; vocabulary details 206 may depict an extended set of vocabulary details), and other basic knowledge such as some notion of the meaning of the words. In addition, depending on the application, there might be geographical information (states, cities in states, etc.), information related to specific management applications (details about different car models, if PAM claims to be able to manage your car, or details about different drugs, or at least information about where on the Internet to find that information in a form that PAM can understand). Under certain embodiments some knowledge is effectively implicit in the reasoning and processing logic. For example, classes are used to represent English words and phrases, among other things. Reasoning and processing logic may process a sub-tree arrangement of classes (representing a phrase) to identify a certain word having semantic significance to the logic; for example, some logic processes class tree entities to identify a word referred to herein as a “head word.” In these embodiments the head word is identified by its positional relationship in the tree arrangement relative to other class details for the phrase and by its details (as opposed to being identified with a specific flag or other structure to explicitly identify the detail as a head word). Thus, at least in this sense, the reasoning and processing logic have inherent knowledge about the structure and semantics of how to process a phrase to identify a head word. It will be appreciated that other arrangements of knowledge, trading off explicit identification and processing complexity may be used without departing from the inventive concepts.

The inventors envision common sense reasoning logic 106 that specifies specific domains and specific reasoning problems within a domain. For example, exemplary domains include time reasoning logic 208, location reasoning logic 210, amount reasoning logic 212, and name reasoning logic 214. The inventors also envision (though it is not necessary for this invention) that the reasoning logic may be implemented in a NL-based procedure language. However, the reasoning logic may be implemented in other programming language; some may be in the NL-based procedure language, and some may be, for example, axiomatic.

The higher-level application (PAM) 108 is expected to include a set of procedures, which again may be (but need not be for purposes of this invention) a set of NL-based procedures. The application may also access the profile directly, and is scheduled to execute via engine 216.

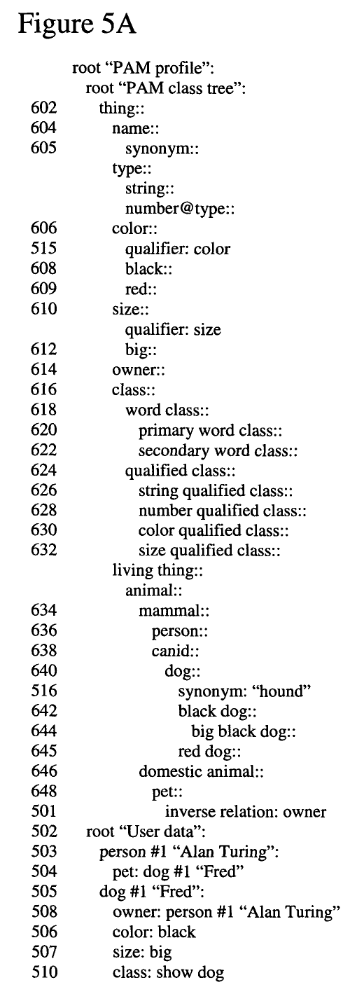

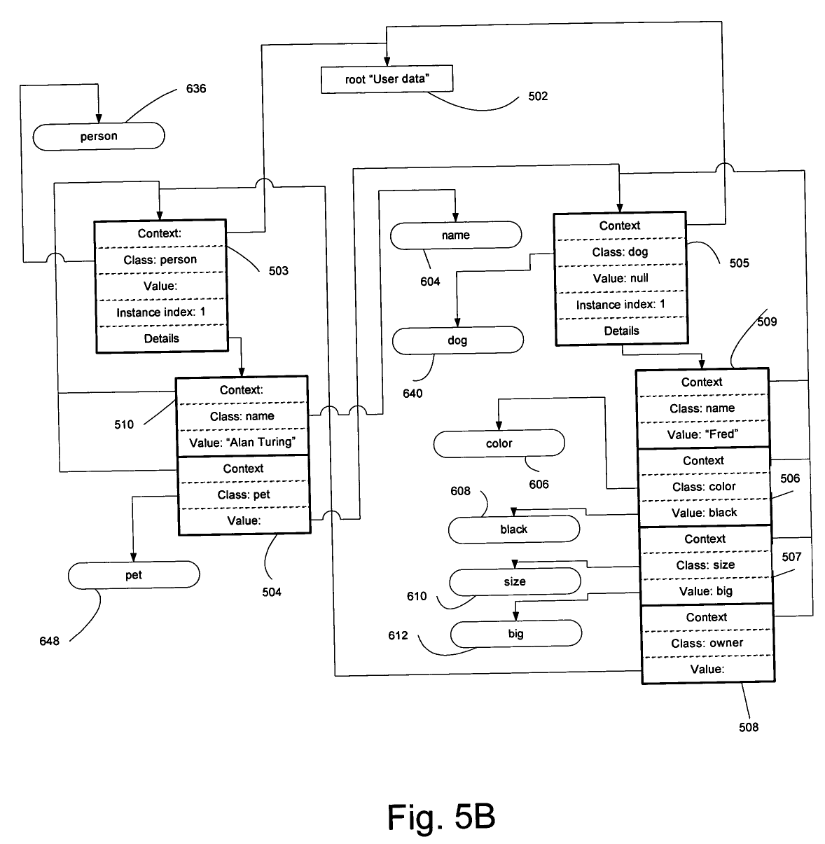

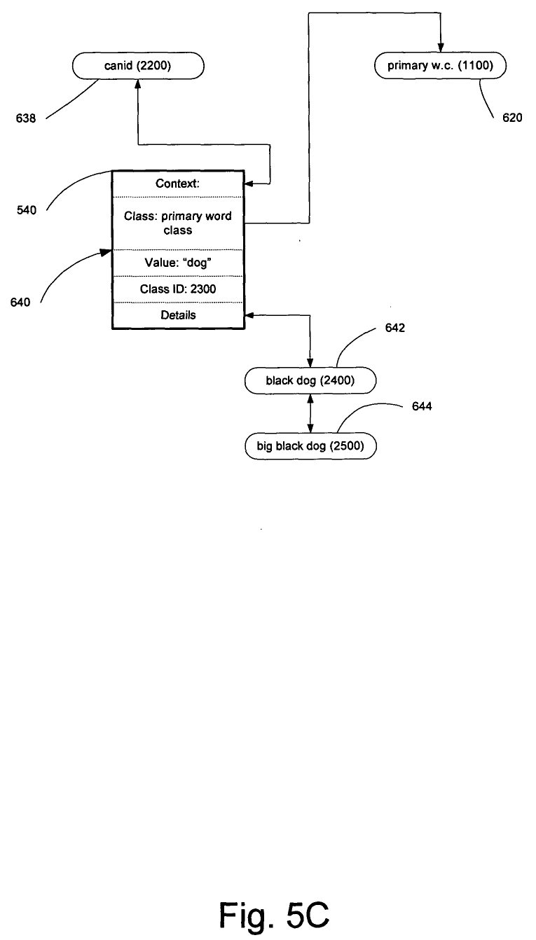

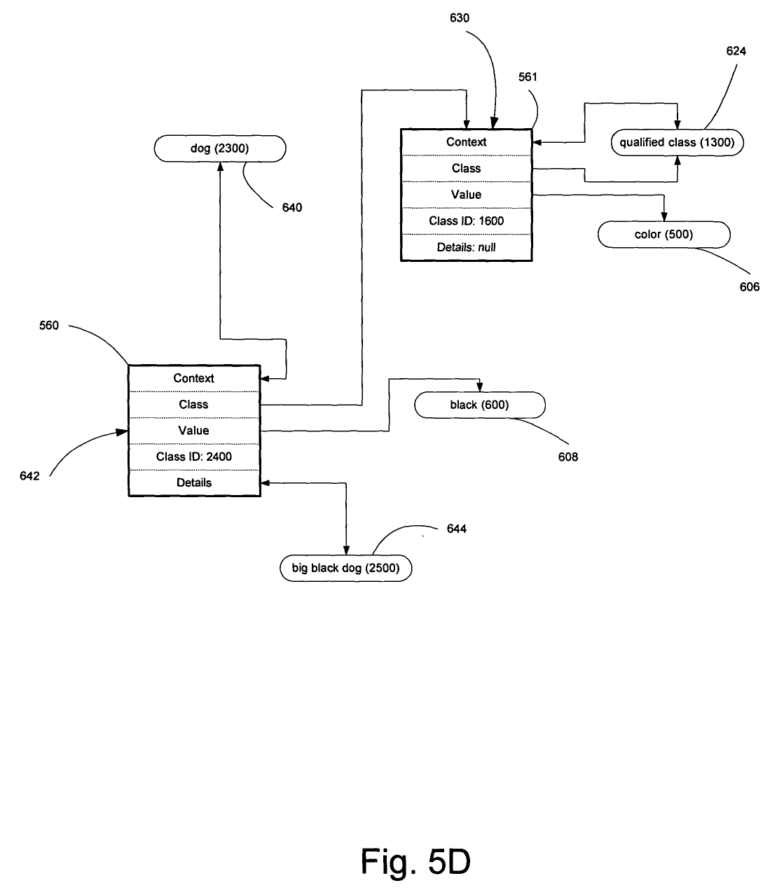

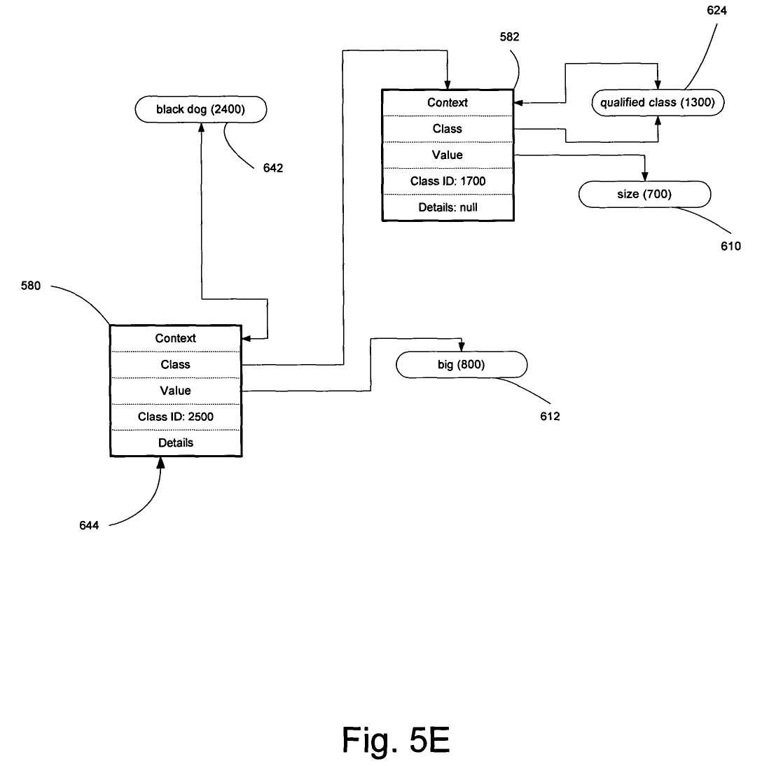

As described later, the modules 218 load a profile from external sources, whether disk files or network connections, periodically save it, and maintain journal files to allow recovery in event of a system crash. In the preferred embodiment, the profile is stored in disk files in the human-readable KAL format shown in FIGS. 5a, 8, and 9; other embodiments could use proprietary binary formats, a relational database, or any of a number of other storage mechanisms. The modules 218 specifically convert the human-readable format to and from computer data structures, both for the initial loading of the profile into platform memory and for loading of extensions or plug-ins from the network.

The connections between boxes in FIG. 2 generally indicate a combination of data flows and program invocations. Further, any data modules (shown in FIG. 2 as rectangles) are, in the preferred embodiment, encapsulated in high-level language classes that mediate all access to them. For example, access to the class tree 204 by a module such as the engine 216 is not direct access of data structures; rather, it's the invocation of preprogrammed software that implements an application programming interface (API) for access to the class tree 204.

The high-level PAM application will begin execution by loading the profile through the code 218. Most commonly, the profile will be found on the host computer hard drive 228; the KAL parser 226 contains code to find the profile, and parse it into tokens that are then assembled into an in-memory profile by the KAP (Knowledge Assembly Program) module 220. The KAP module 220 calls operations on the profile 202, class tree 204, and vocabulary 206 data structures to cause them to be constructed, finalized, and made available to the rest of the system.

During system operation, in turn, the profile API will invoke the Save/journal module 222 to journal profile modifications, for crash recovery, or to save the entire profile. It may also, in response to calls from the engine 216, invoke the plug-in loader 224 to enhance the profile by loading information from the internet 230.

The common sense reasoning (CSR) module 106, as described below, consists of several distinct modules that address specific problems domains. The diagram shows four such domains, time 208, location 210, amount 212, and name 214, but the preferred embodiment includes several others, dealing with areas such as class reasoning, objects, actions, and so on. All CSR routines operate in some way on data in the profile 202; they may be invoked by the profile API in some cases, by the engine 216 directly, or by PAM procedures 108. As discussed below, particular CSR procedures provided in 106 may be implemented entirely in a high-level language, or may instead be built as more general routines that reason with axioms obtained from the profile 202 and particularly the class tree 204.

The engine 216 controls operation of the system as a whole. As already mentioned, it invokes profile loading 218 to obtain the profile initially. It then performs tasks on behalf of the user directly, and executes PAM procedures 108 to manage objects represented in the profile. Input from, and output to the user is provided by the utility procedures 220, and may take any of a number of forms in different embodiments: a conventional GUI, speech input, handwriting, and so on. The engine manages the conversation with the user, uses the vocabulary 206 to recognize the user input, and processes it, as a command, an assertion (which adds information to the profile), or as an answer to a question.

PAM procedures 108 are initially obtained from the profile 202, where they are in the preferred embodiment associated with specific instances or classes representing things under PAM's management. The engine 216, in this embodiment, may convert such procedures to an easy to evaluate form, or may interpret them directly from the profile; the data block 108 represents both the compiled form, and the execution state needed by the procedures. In the preferred embodiment, the execution state will actually be stored as part of the profile, allowing it to be saved and restored as needed.

The engine's primary responsibilities, aside from managing and dealing with user input, are therefore the scheduling and execution of threads of execution associated with procedures, and the management of their state. As shown in later figures, a PAM procedure may be as simple as, “remind the user to take his prescription every day at noon”; the thread of execution for this will be represented as items in a profile data structure that the engine 216 will use as a calendar for managing its own “appointments.” Notification of the user is a task that will be invoked in some way through the utility procedures 220, perhaps involving sending email, originating a phone call, or bringing up a dialog on the host computer.

The engine can use CSR routines 106 to assist both in scheduling its own actions, and as part of the execution of PAM procedures. It also accesses the profile API directly, on its own behalf (in the preferred embodiment, execution state is kept in the profile), and on behalf of procedures that require specific information, or that need to store specific information.

The Knowledge Base

### Overview

Preferred embodiments organize the information and knowledge in a profile 202. The profile may contain a wide range of information, ranging from a user's personal details (e.g., date of birth) to general knowledge about the world (e.g., Boston is a city in Massachusetts). In a conventional database system, it would be difficult (if not impossible) to represent such a huge range of information while preserving any useful structure—that is, it would require either an enormous effort to define the database schema or an enormous effort to extract useful information from unstructured text.

The “ontology” of the profile, the reasoning logic, and the application effectively consists of “things” that can be specified in English. “Things” can be physical objects, abstract objects, classes, properties, states, actions, events, assertions, theories, stories, etc. Things can be actual or conceptual, singular or plural, etc. Things can be specified by noun phrases, verb phrases, adjectives, sentences, paragraphs, memos, etc. A profile can include personal, common, specialized, linguistic, procedural, and state knowledge.

This is possible because preferred embodiments create and maintain data structures representative of the client's NL expressions of knowledge. The knowledge is organized as a potentially enormous number of details organized according to a relatively small number of specified relationships. As outlined above and explained in more detail below, the relationship at the highest level may be considered as context/detail and in this sense certain embodiments organize all information according to such a relationship. However, other embodiments exploit more specific kinds of relationships, such as class/instance, etc., explained below. The predefined organizational relationship of details and the relatively limited number of types of relationships facilitate processing of the knowledge by various forms of reasoning logic. Moreover, as explained below and alluded to above, despite the relatively limited number of kinds of relationships and despite the predefined organizational relationship, the preferred embodiments allow an enormous range of knowledge to be expressed within such a structure. As stated above, the approach allows assertions and statements no matter how conceptual, precise, ambiguous or concrete to be organized within a profile.

The profile structure of preferred embodiments is a “detail tree” (of maybe millions of details). The profile can be arbitrarily large in size and broad in scope. Any sub-tree of a profile tree may equivalently be referred to as a context tree or a detail tree. A profile as a whole may be regarded as a knowledge base (database) of personal, common, specialized, linguistic, knowledge, organized as a unified detail tree.

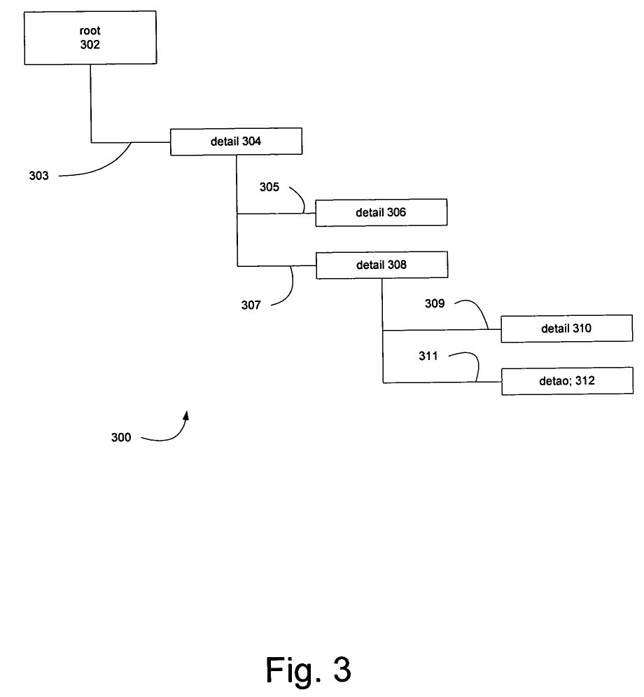

FIG. 3 is a high-level depiction of the organization of a detail tree 300 of certain embodiments. A detail is so called, because it is a detail of its “context,” which in turn is a detail of its context, and so on up to a “root context,” which, though a detail, is not a detail of anything. The detail tree 300 includes a root context 302 with a reference 303 to a detail 304 (only one detail is shown for the sake of simplicity). Detail 304, in turn, has references 305, 307 to details 306, 308. Detail 304 is the context of the details 306 and 308. “Context loops” are disallowed under preferred embodiments.

In preferred embodiments, as outlined above, the thing represented by a detail d (e.g., 304) can generally be said to “have” the things represented by details (e.g., 306, 308) of the detail d, in various particular senses of the word “have”. The actual sense of the word “have” can be inferred by consideration of the class of detail d and possibly of the class of its context. There is no requirement that sibling details, e.g., 306, 308, each be related to their common context by the same sense of “have”; for example, reference 305 may correspond to a “have as an attribute” but reference 307 may correspond to “have as a possession.”

Because of the information that details contain and/or reference (in conjunction with their organization within a tree), details can be readily translated into and from English. Certain preferred embodiments maintain the profile detail tree 300 in computer memory (or the like) and maintain a text file representation of the profile as a form of source code file that may be used for saved versions, for journaling, and for human inspection or modification of the profile (hereinafter the text file is called a “KAL” file, KAL being an acronym for Knowledge Assembly Language).

Likewise, preferred embodiments include program logic 218 that can parse English phrases to get them into semantically useful qualified class form so that they may be used by the system and be used within a KAL file. The program that parses a KAL file, including any English phrases that it contains, is hereinafter called “KAP,” KAP being an acronym for Knowledge Assembly Program. “KAP” refers to the software that takes KAL and builds a profile from it. It uses, among other things, logic that parses the English phrases. In the preferred embodiment, the same English parsing logic is available in general, for parsing user input in certain cases.

As will become apparent from the description below, under certain embodiments the profile organization may change even if the substantive knowledge does not. For example, when a knowledge base is extended to include some new knowledge expressed by the client, the profile will extend to model the new knowledge in a certain way representative of the various phrases, assertions, etc. in the expression. At a subsequent point, software logic may attempt to store the profile. As will be explained below, the storing process will load the profile into a text file or the like using an intuitive notation that fully represents the knowledge. At a still later point, that stored profile may be loaded back in computer or platform memory. The resulting loaded profile may have a different organization than the one that was created when the new knowledge was entered. This will be explained in more detail when describing KAP/KAL logic 218.

Moreover, the profile may be changed by modifying contexts of certain knowledge. This approach will preserve the semantics of the knowledge base but can facilitate processing and visibility of certain knowledge. For example, suppose a particular person has a daughter. At one point in time, a corresponding profile might specify that the person is a context and the daughter is a detail (i.e., the person has a daughter) and various other details of the particular person and daughter may be included in the profile (names, spellings, etc.). The daughter details would be at a lower level of the profile tree hierarchy than the context of the person.

At a subsequent point in time, the logic may attempt to change the context of the daughter within the tree organization. In this case, the daughter detail for example might be moved to a level in the hierarchy equal to that of the particular person detail. The new high-level detail would most likely be a “person”; the detail for the parent would still have a daughter detail, whose value would be a reference to the new person. The general rule is that the class of the new detail will be based on properties of the thing represented by itself, rather than based on its relationship to its original context (“person” vs. “daughter,” “dog” vs. “pet,” etc.). It often will be a superclass of the class of the original detail, but (as with dog/pet) need not be. The particular person would still have a daughter, but now the detail for the particular person would have a reference to the details representative of the daughter. In other words, the daughter details, which previously may have been represented by value, may now be represented by reference. The new positioning of the daughter details may improve visibility and processing of such by reasoning logic and the like.

### Details

Preferred embodiments, as explained above, implement the profile tree as a tree of details. Details are represented as detail structures (hereinafter “detail structures” are often referred to as simply “details” or with the abbreviation ‘d’).

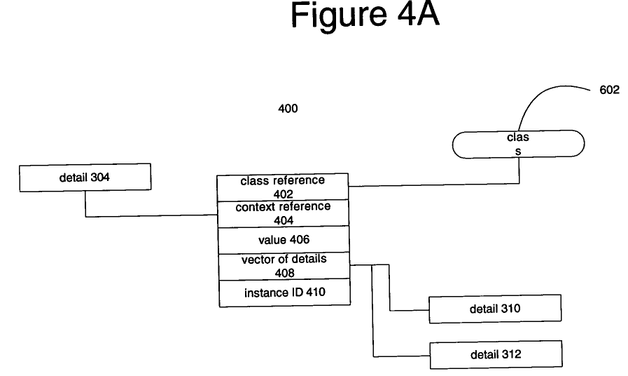

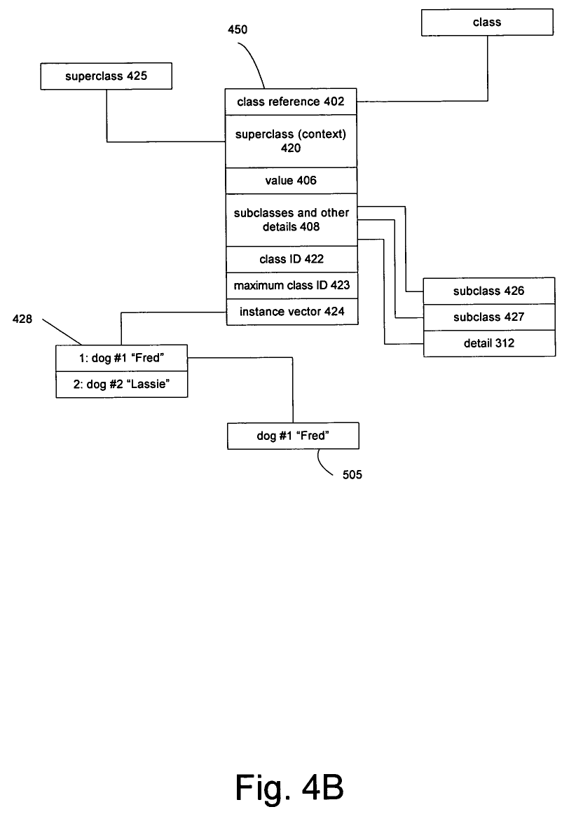

FIG. 4A depicts an exemplary detail structure 400 used to represent the detail 308 in the exemplary profile tree of FIG. 3. Thus reference to both figures conjointly may be helpful.

The detail structure 400 includes the following:

a class reference 402.

a context reference 404.

a value 406.

a vector 408 of references to details of the detail 308.

an instance identifier (ID) 410.

The class reference 402, as the name implies, refers to a class. The reference may be implemented in any of a variety of ways, such as pointers and the like. A “class,” in short, may be used to structure the knowledge base; e.g., the class “car” might be a subclass of “vehicle.” A class is a certain type of detail that typically corresponds to an English word or phrase and that specifies what kind of thing detail 308 is, or, if detail 308 corresponds to something plural, what kind of thing an individual element is.

Since the class is a detail, it too is represented in software logic by a structure 400. Classes however have certain rules about their use and potential settings for their components 402-410 (as discussed herein) and they can be used by specific reasoning logic for specific purposes. For example, reasoning logic might consider various details 310, 312 of detail 308 (which is the context for details 310, 312), but reasoning logic might also want to consider what kind of thing detail 308 is when doing such reasoning. To do so, the reasoning logic would consider the class 602 (pointed to by class reference 402) and other class information (e.g., superclasses of class 602, details of class 602, etc.). Some embodiments represent a class instance using the structure of FIG. 4B, where the context reference 404 is interpreted as a superclass reference 420, and the vector of details 408 includes subclasses of the class. The new elements maximum class ID 423, and instance vector 424, are used to enhance performance of the overall system, rather than affecting the semantics of the data structures in any way.

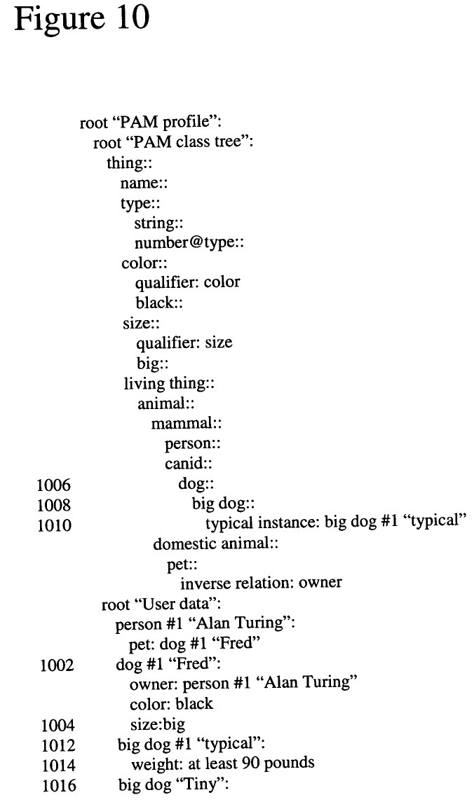

FIG. 10 shows a small, incomplete section of an exemplary profile, similar to that in FIG. 5a. In FIG. 10, entity 1002 represents a specific dog, whose size, represented by entity 1004, is “big.” When reasoning about transporting this dog in a carrier, software could recognize that the dog entity (i.e., instance 1002) has no indication of the dog's exact size; instead, the software would refer to the class dog 1006 (e.g., by identifying the class 1006 via the class reference 402 of the detail structure of the dog instance 1002). A subclass big dog 1008 would match the dog 1002, based on the dog's 1002 size detail being “big”; that class 1008 includes a typical instance detail 1010, whose value refers to the big dog with instance ID 1. Big dog 1012, i.e., the typical big dog in this profile, in turn includes a weight detail, 1014. So the software can deduce that “big dog” typically is a dog weighing more than 90 pounds, and therefore have some basis for determining the size of the carrier needed for dog 1002 even though the profile contains no specific weight for the specific dog represented by 1002.

The context reference 404, as the name implies, refers to a context. The reference may be implemented in any of a variety of ways, such as pointers and the like. As explained above, a context is also a detail. With reference to FIG. 3, detail 308 has a context 304. All details, except the profile root, have a context and therefore all details have a context reference referring (e.g., pointing to) another detail. The root has a context reference but this reference is a null pointer.

Value 406 is used to refer to or hold specific information. All details that are a class have certain types of value information, specifically, the “spelling” or “qualifier” for the class (more below). However, details that are an instance may or may not have value information, and if they do have value information it may specify the instance in an English-based way and in a typically less context-dependent and sometimes more general way; e.g., my car has a color detail, and the value of that detail is a representation of the class red, or I have a daughter detail, and the value of that detail is another detail representing the person who is my daughter. The value may also contain a string—my dog's name is “Fred.” Numbers (the dog's weight is 90 pounds) and lists of other values may also be used.

If the detail represented by structure 400 is the context of other details in the profile, the vector 408 will have references to all such other details. Like the above, the references may be implemented in any of a variety of ways. Preferred embodiments implement the vector as a canonically-ordered vector 408 of references, which is further described below. The canonical ordering that we refer to and explain herein is based primarily on class IDs; in cases where numbers or strings appear as qualifiers, then they may also be used as subkeys for the sort.

Instance ID 410 is used to uniquely identify an instance of a class. Identification may be done in a variety of way, including for example unique positive integers. Uniqueness may be enforced on a per class basis. Classes do not (but of course could) keep vectors of references; in alternative embodiments in which classes do keep vectors of references they could have a canonical ordering. The instance ID helps identify the instance in a KAL file. For a class, the ID identifies the class, e.g., the number assigned to this class in the current numbering of all the classes; the class ID is not, in the preferred embodiment, stored in a KAL file.

As stated above, instances and class have rules and logic regarding how certain components of the detail structure 400 may be set and modified. For example, when a detail structure is created (e.g., either by loading of a KAL file into memory of the platform or during dynamic extension of the knowledge base during processing of the system), the class reference 402 and context reference 404 are set to point to the corresponding entities, e.g., class 602 in FIG. 4A and context 304. Preferably, these are rarely changed thereafter (though as noted above sometimes these may be changed to advantage). Generally speaking, changing the class of a detail is (and should be) severely restricted in preferred embodiments. If you create a book detail, you should not convert it to a chair. You can downcast it, however, by changing its class to a subclass of its present class—a book can be converted to a dictionary. In preferred embodiments, upcasting (dictionary->book, or dog->domestic animal) is disallowed. Likewise, the vector 408 is set to include a reference as well. Thus a detail structure for context 304 would appropriately record in its vector of details a reference to detail 308 when detail 308 is created. Moreover, as outlined above the rules and logic for setting and changing components may differ depending on whether the structure represents a class or an instance. For example, in the case when the detail 400 represents a class, the value 406 should never be changed (under preferred embodiments). In the case when the detail is an instance, the value may be changed freely; i.e., an instance, with its value, can serve as a “variable.” An instance ID 410, where present, is generated and maintained automatically. However, since certain embodiments allow profiles to be stored externally as a KAL file, or a KAL file set, a developer can, through text editing, manipulate classes, contexts, details, and instance indices outside the control of the software.

FIGS. 5A-E depicts a subset of an exemplary tree to illustrate the above entities and how they may be inter-related. This figure will be used to illustrate various other aspects as well. Of immediate relevance FIG. 5A shows the KAL format of the tree, with needed class definitions, and two high-level details, a person 503 and a dog 505. The person has a name detail, which is specified on his detail line 503, and a pet detail 504, the value of which is a reference to the dog 505, using the dog's instance ID. The dog has four details: implicitly a name; an owner 508, the value of which is a reference to the person 503, using the person's instance ID; a color 506, whose value is a reference to the class black 608; and a size 507, whose value is a reference to the class big 612.

FIG. 5B shows the data structures created by the preferred embodiment for these two instances and their details. In this diagram (and subsequent diagrams), single rounded boxes represent classes, single boxes represent instances, and multi-part boxes represent classes or instances at a finer level of detail. In FIG. 5B, structure 503 is the detail for the person in the KAL representation of FIG. 5A: the context reference is shown as an arrow to the root “User data” instance 502; the class reference is shown as an arrow to person 636; the value is empty; the instance ID is 1, reflecting the KAL notation “person #1” in FIG. 5A; the details reference points to a vector containing the person's two details. Structure 510 represents the person's name, with a string value; structure 504 represents the person's pet, whose value is a reference to the dog 505.

Although the details 504 and 510 are shown with only three elements, the preferred embodiment builds all instances with the same structure 400 (see FIGS. 4A-B). We have omitted the empty instance ID and details fields for compactness.

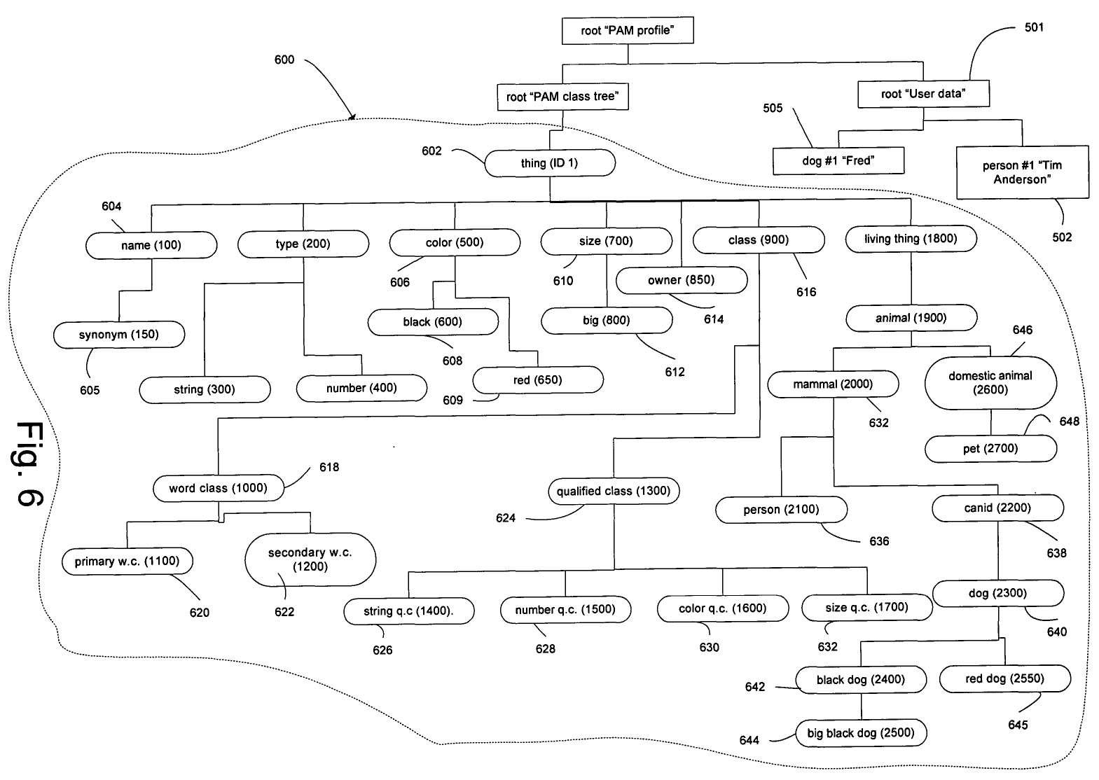

Similarly, FIG. 5B shows the dog instance 505 and its details 506, 507, 508, and 509. The detail vectors shown in FIG. 5B are in their canonical order, based, as discussed below, on the class IDs assigned by KAP during profile loading. Note that the order of the dog's details in FIG. 5B differs from that shown in FIG. 5A; the KAP module reorders all detail vectors to reflect the canonical ordering, regardless of the order seen on input. The classes shown in FIG. 5B are shown in the class tree of FIG. 6, discussed below; the reference numbers starting with “6” in all parts of FIG. 5 correspond to numbers on FIG. 6.

There can be arbitrarily many details in a profile representing a particular thing, though one of these may be recognized as the “primary detail” representing that thing (by some detail of it or its context). For example, in FIGS. 5A-B there are two details representing the dog “Fred”: the person's pet detail 504, and the dog detail 505. In some embodiments the dog detail could be described as primary (that is, have a detail of class descriptor, with the value primary), but here it is enough that the pet detail has as its value another detail, while that detail in turn has no value: the detail with no value is primary, and can be taken as the most general representation of the thing specified. Reasoning logic can use this to identify things referred to by the user: “my dog Fred” can be found by following the value reference of the person's pet detail to the dog Fred. Similarly, it will use this when deciding where to store new information: the assertion “my pet dog weighs 90 pounds” would cause a detail to be added to the primary instance 505 rather than to the pet detail 504; generally speaking, details other than the primary for a specific thing will have no additional details.

Typically, as in this example, the primary detail for the dog is more detailed (itself has details such as size and color) and less context-specific (it is simply a dog, rather than some person's pet) than other details representing the same thing. Because it is less context-specific, it is suitable for use as a value: thus “my pet” has a person as its context, and no additional details, but its value, the dog Fred, can include all details known about the specific animal.

A detail (whether it be an instance or a class) should not be regarded as an “object,” in the sense of an object database or language, even though it may be represented as one in an implementation platform such as NET. For example, it is not object-like in that it (a) does not so much have a one-to-one correspondence with what it represents, (b) is more akin to an English phrase or sentence than to an object, (c) inherits from its class in a very limited way and not in the way typically used in the object-oriented programming art, and (d) has only three independent components (class, context, and value) and no required class-dependent attributes.

### Classes

As outlined above, every detail is associated with (and references) a class. As stated above, a class typically corresponds to a NL (usually English) word or phrase representing a kind of thing, or it represents a prefix or suffix.

For the case when a detail is an instance, the class corresponds intuitively to the kind of thing the detail represents. Thus, the class of the primary detail 505 for the dog Fred is simply dog; the class of the detail 508 of Fred representing his owner is owner, and so on.

For the case when the detail is a class, the class reference references another class (as explained below). FIG. 5C shows the detailed representation of the class dog 540; the class of the detail 540 representing the class dog is primary word class 620—that is, the class is named by a single word, and this use of the word “dog” was regarded by the profile designer or the user as the most common. The context of the detail is the class canid 638; as shown in FIG. 5A, this is the superclass.

FIG. 6 depicts the top-most levels of an exemplary subtree 600 of a profile corresponding to the class tree 204. This tree 600 matches the tree specified by the class definitions in the KAL specification shown in FIG. 5A, and the reference numbers on the two figures correspond. The relationship indicated by the connections between classes at different levels is, of course, subclass/superclass. Since classes in the preferred embodiment are implemented as details, this is represented by the context/detail relationship of details: a superclass has a subclass as one of its details; the context of a class is its superclass. A class will therefore have references to its subclasses in its details vector, and have reference to its superclass via its context reference.

As mentioned above, the details vector of a detail is canonically ordered primarily based on the classes of the details it contains. Since the preferred embodiment implements classes as details, the representation of a class must itself have a class. A class detail will have in its class field a reference to a subclass of the class class. Thus FIG. 5C shows the representation of the class dog 640. The superclass of dog is canid 638; the class of dog is primary word class 620. Similarly, in FIG. 5D, the superclass of black dog 560 is dog 640, while its class is color qualified class 630; the detailed representation of the class color qualified class in the preferred embodiment is shown by structure 561 in FIG. 5D. Thus all the subclasses of a particular class that are primary word classes (i.e., subclasses of class 620) will be “next to each other” in the canonical ordering, because they are of the same class; subclasses that are secondary word classes (i.e., subclasses of class 622) will be next to each other, following primary word classes; qualified classes (i.e., subclasses that are of class 624) will be last, grouped by the qualifier role: all color qualified classes (i.e., subclasses that are of class 630) will be next to each other.

This class sub-tree 600 would preferably be a sub-tree of the profile tree (since the profile tree is a detail tree, and classes are a kind of detail). A large profile could have hundreds of thousands of classes, for example, including a core vocabulary of words and phrases.

A class is itself a detail of class “class,” that is, its class is a reference to the class class 616 or to one of the subclasses of that class. Though a class is a detail, it has tightly prescribed uses of many of the components of its detail structure, such as its class reference 402, context reference 404 (or alternatively 420 for the structure 450 of FIG. 4B), value 406, and instance ID 410 (or alternatively class ID 422 for the structure 450 of FIG. 4B). The context reference is a reference to the superclass, and therefore never changes once the class has been created. Consequently, in preferred embodiments, a class's subclasses are all found in its details vector (see, e.g., FIG. 4B, items 408, 426, and 427). A class's value reference 406 is either the spelling of the word associated with the class (the string “red” would be the value of the class red), or, for a qualified class, the qualifier (a reference to the class black 608, for the class black dog 642). In certain embodiments, the class ID 422 of the detail structure is assigned to provide a numerical ordering of all classes, based on a depth-first, left-first walk of the class tree: the root class “thing” will have the lowest ID. Although the class ID 422 for classes is unique across all classes (rather than across all classes that are of a particular class), the preferred embodiment does not use it to identify classes in the KAL representation; in fact it does not provide any direct mapping from a class ID to the corresponding class. Class IDs, as discussed elsewhere, are subject to change at any time due to class creation; in KAL, class names in standard forms that guarantee uniqueness are used instead, to enhance readability. The class reference indicates the kind of class that this is: it will refer to a subclass of word class 618, for word classes such as red, or to a subclass of qualified class 624. In the case of the qualified class black dog 642 (having structure 560 shown in FIG. 5D), the class reference will be to the class color qualified class 630 (having structure 561 in FIG. 5D); the reasoning code uses this to determine the proper interpretation of the qualifier.

Referring to FIG. 6, a class dog 640 is shown with “immediate subclass” 642 called “black dog”. The immediate subclass 642 is a detail of class 640 (i.e., the structure for class 640 would include a reference in item 408 [see FIG. 4B] to class 642). Class 640 besides being the context of detail 642 is the superclass of class 642. Analogously, class 644 called “big black dog” is an immediate subclass of class 642, but not of class 640 (though it is a subclass of 640).

FIGS. 5C and 5D show more details of the detail structures 540, 560 used by the preferred embodiment for the classes 640 and 642.

Any detail of a class c that is of class class is an immediate subclass of c and represents a subkind of what c represents. Except in the unique case of the root class “thing” 602, the context of a class c must be a class, specifically the immediate superclass of c. A class c1 is a subclass of class c2 (and c2 is a superclass of c1) if either c1 is an immediate subclass of c2 or if the immediate superclass of c1 is a subclass of class c2. A detail is said to be of its class as well as of every superclass of its class. (Note that there can be details in a profile of class class that are not in the class tree and that are not, therefore, classes, as the term class is used here. That is, the dog 505 might have an additional detail class: show dog. Although that is legitimately a detail of class class, it does not represent a class, because its context is an instance. FIG. 5A shows this with item 510.

A class that corresponds to a simple word has a “spelling” and is called a “word class.” The “spelling” is referenced by the value component 406 of the detail structure 400 corresponding to the word class (or alternatively value 406 of structure 450 of FIG. 4B). Thus, for example, class dog 640 (see FIG. 6) has a detail structure 540 shown in FIG. 5C that would have a value component 406 that would reference the string “dog.” The spelling should be the same as the spelling of what it corresponds to, including its usual capitalization.

Preferred embodiments use a hash table to map from a string to every class with the same spelling as the string, capitalization included. This is used to facilitate input processing, both for KAL files and for user input, but is not generally needed for reasoning.

A class that corresponds to a composite word or a phrase or a prefix, or suffix is called a “qualified class.” A qualified class 624 has a “head word class” and a “series of qualifiers”. With reference to FIG. 5, specifically 5A and 5D, a qualified class c has, as its value, a qualifier, which can be a number, a string, a class, or a list of any of these (including “embedded” lists). For example, class 644 is a qualified class and is called “big black dog.” Class 642 (having structure 560) is also a qualified class and is called “black dog.” The head word class for such is class dog 640. The qualified class “black dog” 642 (having structure 560) has a value 406, which is a reference to class 608 “black.” Because a qualified class like “black dog” 642 carries in its name enough information to place it in the class hierarchy, the preferred embodiment can define such classes when they are used in a reference, and does not require, but allows, an explicit definition in the KAL form of the profile (such as shown in FIG. 5A). Standard parsing algorithms, using the profile of 5A as a lexicon, will identify “black dog” as a color-qualified subclass of dog 640, with the qualifier black 608, regardless of its exact location in the KAL representation.

Reasoning logic can identify a qualified class's head word class by traversing the tree upward (using context links) from a relevant qualified class until it encounters a word class, which can be taken to be the kind of thing that the qualified class really represents. The logic can detect when it encounters a word class by considering the class referenced by entity 402 (see FIG. 4B) and detecting that the class is a word class, that is, is a subclass of the class “word class” 618. Thus, the head word class for big black dog 644 is dog 640 (having structure 540 in FIG. 5C; notice the class reference to primary word class 620).

The only limit on the complexity of natural language phrases represented by qualified classes is the ability of the system to parse them in an understandable way. For example, the phrase “walk the big black dog named Fred” would be represented as a qualified subclass of the action “walk”: walk [object:dog [color:black, size:big, determiner:the, name:“Fred”]]. The notation used here, as discussed elsewhere, permits the direct representation as qualified classes of arbitrary phrases, including those that the preferred embodiment cannot understand in their natural language form.

Although a phrase like “big black dog” specifies a class of animals, the preferred embodiment does not as a rule create instances of such classes. Instead, it will create instances of the head word class (dog, in this case), with details derived algorithmically from the qualifiers of the class. In the example of FIG. 5, the class big black dog 644 might have been created as part of the interpretation of a user input, “my big black dog named Fred.” The preferred embodiment would then create the instance 505 of class dog, with a size detail 507 whose value is big, and a color detail 506 whose value is black. This approach leads to representations of new data that are less dependent on the exact form and sequence in which they were described, and are therefore easier to reason about: the dog 505 would have the same representation if the user instead said, “my dog named Fred,” and much later said, “Fred is a big dog,” and, “Fred is black.”

Conversely, class reasoning logic will use the head word class and qualifiers of a class to determine class membership in a more general way. Although the dog 505 is formally an instance of the class dog 640, reasoning logic will permit the system to respond correctly to the question, “Is Fred a big black dog?” which can be rephrased as, “Is Fred an instance of the class named ‘big black dog’?” He is: he is a dog, and has color and size details that match the qualifiers of the class.

Note that in preferred embodiments a qualifier should not be an instance; that is, if the value of a detail representing a qualified class is a detail, then it must be another class. There are several reasons for this restriction: syntactically, it is complicated to include an instance reference in a phrase; semantically, it is unclean to base a class on a specific instance. Finally, there is no loss of generality implied. For example, the qualified class “all of the books on my desk” has as a qualifier the qualified class “my desk,” which will generally identify a single detail, but does so without being an instance. A qualifier in some way qualifies the kind of thing represented by the immediate superclass of c, to determine the kind of thing c represents. Thus, what a qualified class represents depends, in part, on how its qualifier “qualifies” its immediate superclass, which in turn depends on the class of the qualified class.

In FIG. 5D, the class of the class 642 “black dog” (having structure 560) is color qualified class 630 (having structure 561). The qualifier (value) of black dog is a reference to the class black 608. The combination of the two tells the reasoning logic that this class refers to dogs whose color is black, rather than to dogs whose mood might be described as “black.” Reasoning logic might easily convert such a qualified class into an instance of the head word class with details obtained from the series of qualifiers; thus the dog 505 (see FIG. 5A or FIG. 6) could have begun life as the qualified class big black dog, which reasoning would turn into a dog with appropriate color and size details.

The class of a qualified class is of the form “qualifier-role qualified class”, where qualifier-role is a class such as object, size, color, determiner, location, time, means, ordinal, etc. The qualifier role for the class of a qualified class is often, though not always, derivable from the class of the qualifier or from the class of the qualifier and the immediate superclass. Referring to FIG. 5A, the class black 608 is a subclass of the class 606 color; class 606 has a detail (not a class) 515, which is an instance of qualifier with the value color. In some embodiments, the reasoning logic would search superclasses of the class black to find this detail, and would therefore identify color as black's qualifier role, resulting in the class structure 560 of FIG. 5D.

Here are some samples of qualified classes and their respective immediate superclass, qualifier, and qualifier role components (all expressed, in these cases, identically in both KAL and in English). These samples are representative (for the sake of clarity) but the list may be much larger and more comprehensive.

| | immediate | | |
|---|---|---|---|
| class | superclass | qualifier | qualifier role |
| left arm | arm | left | side |
| model name | name | model | type |
| the book | book | the | determiner |
| 10 books | book | 10 | quantity |
| unmanaged | managed | -un | negation |
| turn up | turn | up | direction |
| turn up volume | turn up | volume | property |

Note that the term qualifier is used here in a broader-than-usual sense, encompassing determiners, quantifiers, etc.

In the preferred embodiment, there are several qualifiers and roles that are defined by the system, and added to the profile if necessary, to ensure that it can represent classes consistently, represent word morphologies, and navigate through the class tree. The following table shows the predefined roles, associated qualifiers, and their purpose:

| Role | Qualifiers | Purpose |
|---|---|---|
| structure | word, | “word class” is word [structure: word]; |
| | qualified | “qualified class” is word |
| | | [structure: qualified] |
| string | string | For classes whose name includes a |
| | constants | constant string. |
| number | numerical | For classes whose name has a constant |
| | constants | number leading: “1 step,” “2 step.” |
| ordinal | numerical | For trailing constant numbers: “step 1,” |
| | constant | “step 2.” |
| quantity | plural, all, | Most important for word morphology: “dogs” |
| | some | becomes the qualified class dog is word |
| | | [quantity: plural]. |
| tense | past tense | For word morphology: “walked” becomes |
| | | the qualified class walk [tense: is word |
| | | past tense]. |
| determiner | the, a | “The dog” becomes dog [determiner: the]. |
| list | lists | A functional call in conventional notation, |
| | | such as “cosine (x),“ becomes cosine |
| | | [list: x]. |

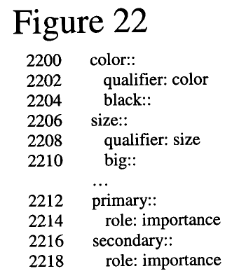

The preferred embodiment uses information obtained from the profile to assign roles to qualifiers in phrases that it encounters. The selection from an exemplary profile in FIG. 22 illustrates this. The class color 2200 has a subclass black 2204, and a qualifier detail 2202 whose value is a reference to the class color. When the preferred embodiment encounters a class whose qualifier is black 2204, and where the qualifier does not itself specify a role, as described below, it searches successive parent classes for a qualifier detail, and uses that as the role. Thus, “black dog” will become a color qualified class. Similarly, the class size 2206 has a qualifier detail 2208, whose value is a reference to size; if the subclass big 2210 is used as a qualifier, by default its role will be size. This allows “big black dog” to be recognized as dog [color:black, size:big].

The classes primary 2212 and secondary 2216 both specify their roles directly, by using the role details 2214 and 2218. The preferred embodiment first looks at the qualifier itself for a role detail; if it is found, then that will override any qualifier details that might be in a parent class. This specifies the role for the qualifier primary in “primary word class.”

This also illustrates that the set of roles is not fixed, nor is the mapping from specific qualifiers to roles. In the preferred embodiment, this information is obtained from the profile according to the method described here, so is subject to change by users or developers. The mapping is very important, because it is a primary source of the semantic knowledge that the system depends on for its reasoning ability.

More specifically, the head word class of a qualified class c is the first word class encountered in moving up the class tree from c through successive immediate superclasses. The series of qualifiers consists of the qualifier of c (the outermost qualifier) followed by the qualifiers of successive immediate superclasses, if any, that are qualified classes. The last in a series of qualifiers is the innermost qualifier. FIG. 5E shows the details of the class big black dog 644 (having structure 580). Big black dog is a subclass of black dog 642. The outermost qualifier for 644 is big 612, reference by the value component of structure 580; the next one in (and innermost) is the qualifier for the parent class black dog, black (shown in connection with FIG. 5D). Note that successive immediate superclasses of a qualified class c that are themselves qualified classes have the same head word class as c but successively shorter series of qualifiers, dropping outermost qualifiers one by one. Such successive immediate superclasses of c are, of course, superclasses of c, as is the head word class of c.

A qualified class can be represented in KAL either “naturally” as a phrase or decomposable word spelling (see below) or notationally in qualified class notation. Under preferred embodiments, a qualified class in qualified class notation is of the form

head-word-class [qualifier-role-1: qualifier-1, qualifier-role-2: qualifier-2, . . . ]

where the order of qualifiers is innermost to outermost, where qualifier roles can be omitted if they are easily derivable, where this notation can intermingle with phrases, and where a save option determines whether to save qualified classes as phrases or in this qualified class notation.

For example, as described above, the class 606 color in FIG. 5A has a qualifier detail 515, with the value color. In some embodiments, this will be taken to mean that the default qualifier role for any subclass of color, such as 608 black, is color; absent other information, this is easily derivable (by searching successive superclasses of the actual qualifier for details of class qualifier), so it could be omitted. If, however, black is being used to describe a mood, the role does not match the default, is therefore not easily derived, and must be included. As an example, the phrase “very few big black dogs in the neighborhood” might be parsed as

dog [color: black,

size: big,

location: neighborhood [quantity: the, proximity: in],

quantity: few [very]],

or, more succinctly, as

dog [black, big, neighborhood [the, in], few [very]].

Note that the plural inflection on “dog” is subsumed by the quantity qualifier.

As an example of the fact that successive immediate superclasses of a qualified class c are superclasses of c, note that the class dog 640 is the immediate superclass of 642 black dog, which is the immediate superclass of 644 big black dog.

As an overall rule, two distinct classes cannot, in a profile, have the same context (immediate superclass) and value (spelling or qualifier).

Every class has an implicit (and essentially unique) name-like representation, its KAL representation (see below). For the word class black 608, the KAL representation is simply the character string “black.” For the qualified class big black dog 644, the KAL representation is the phrase “big black dog.” In addition, a class may have any number of other names of various kinds, represented as name details, typically with string values. The class dog 640, in addition to the name “dog,” has a detail which is a synonym (synonym class 605 is shown in FIG. 6 as a subclass of name 604; the detail synonym for dog 640 is shown in FIG. 5A, 516) with string value “hound,” thus identifying another name for the class. In the preferred embodiment, “hound” would be recognized on user input as a reference to the class dog 640, but on output the class's name “dog” would be used instead. (Note that when we say something is “a c detail”, we mean that it is a detail of class c.) A synonym, for example, is treated as another name for a name.

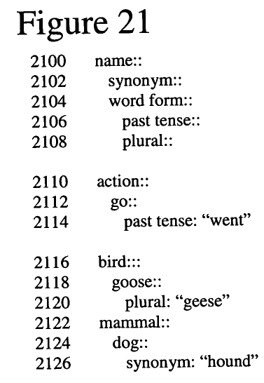

As shown in FIG. 21, the use of names can extend to the representation of word forms. The class name 2100 has subclasses synonym 2102 and, and as subclasses of word form 2104, past tense 2106 and plural 2108. The class go 2112 has a name (because past tense is a subclass of name) detail 2114 with value “went”; similarly goose 2118 has a plural detail 2120 with value “geese.” As also shown in FIG. 5A, and discussed above, dog 2124 has a synonym detail 2126 with value “hound.” In the preferred embodiment, regular word forms are used to generate qualified classes; that is, “dogs” need not be in any lexicon, because it can be recognized using standard word morphology algorithms as the plural form of “dog,” and therefore converted into the qualified class dog [quantity:plural]. In the same way, the word “geese” can be recognized as the plural form of “goose,” because it will be in the lexicon as the value of the plural detail of the class goose; thus it will be converted on input to the class goose [quantity:plural], just as “went” can be converted to go [time of action:past]. This supports reasoning by separating the spelling of a particular word form from its representation in the profile, just as synonyms allow many different words to mean the same thing; only word forms that are actually used will cause qualified classes to be created, and only word forms that cannot be understood algorithmically need explicit mention in the profile.

It is recognized that, under certain embodiments, instances of a class cannot in general be efficiently located. Thus, for example, it is very inefficient in these embodiments to delete classes. However, a class might have details of class “typical instance,” example, etc. whose values refer to instances of the class. In FIG. 10, the class big dog 1008 has a typical instance as a detail whose value is an instance of big dog, 1012. This allows reasoning logic to obtain a rough value for the weight of a specific dog described as “big” without further information—though of course it might eventually get a weight detail for the specific dog, in which case the weight will be a detail of the specific dog and not a weight that is inferred by reasoning logic through use of the “typical instance” information. The typical instance of the class is easy to find; in contrast, the big dog 1016 has no direct references from the big dog class, and so in the preferred embodiment would have to be found through other references, or by searching the entire profile.

Under certain embodiments, a class might have a structure cataloguing instances of the class that have instance indices (see below). For example, in the profile, the canonical representation of a value that's an instance is just “class-name #instance-ID.” Preferred embodiments use such representation to map quickly from an instance index to an actual instance. FIG. 4B shows this as the instance vector 424, a reference to the structure 428. This would allow KAP to quickly find the dog instance identified by “dog #1”; otherwise, it would either have to keep track of every instance of every class, or search the entire profile to resolve such references.

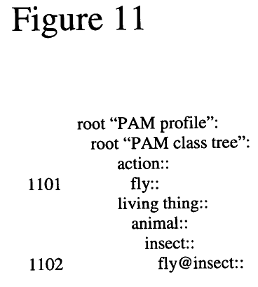

A “primary word class” 620 is a word class 618 represented in KAL simply by its spelling. A “secondary word class” 622 is a word class 618 represented in KAL by its spelling, followed by an at-sign (@), followed by a representation of its immediate superclass. If there are multiple word classes with the same spelling, at most one can be a primary word class. The class of a primary word class is primary word class. The class “dog” 640 in FIG. 5A is an example; its structure is shown with more detail in FIG. 5C as entity 540. The class of a secondary word class is secondary word class: FIG. 11 shows a small section of an exemplary profile, with the primary word class fly 1101, and the secondary word class 1102 fly@insect. The structure of a secondary word class is identical to that of a primary as shown in FIG. 5C, with the single exception that the class reference is a reference to secondary word class 622 rather than to primary word class. (Note that there can be circumstances where two distinct word classes with the same spelling are vying to be primary in KAL and where the system must thus convert one of them, typically the one defined in a “plug-in”, to be secondary. Therefore, the primary/secondary distinction should be regarded as primarily notational. In some embodiments, if an English phrase is ambiguous, the ambiguity will be resolved by assuming that the primary word class was intended. For example, “fly home” could be the action of flying home, or a home for insects; in the example of FIG. 11, the primary form of “fly” is the action, so that will be preferred.)

A class may have various “procedure details.” A procedure detail of a class c applies to every instance of c except as “overridden” by a more-specific procedure detail of the same kind on a subclass of c or on the instance itself. (A procedure is a model of how to carry out an action that is written in English and broken down into steps, and should not be confused with procedures or methods in high level, compilable languages such as C.)

In preferred embodiments, there is a class numbering of all the classes in a profile. This class numbering is recorded in the class ID 422 of the detail structure for each class.

The numbering starts with the class thing 602, according to a “pre-order traversal” of the class tree 204. (A pre-order traversal of a tree first visits its root and then recursively traverses each of the children of that root in order.) For purposes of the traversal, subclasses are ordered according to a predefined rule for canonically ordering details that have the same class. In the preferred embodiment, the rule states that all details of a particular class or instance are ordered first by the class ID of their classes.

Thus, referring to FIG. 6, primary word classes will have as their class primary word class 620, whose class ID in this example is 1100; secondary word classes will have as their class secondary word class 622, whose ID is 1200. Therefore all secondary word classes will sort together after all primary word classes. Qualified classes will have as their class a qualified class derived from the role; the class black dog, which has color as the role for the qualifier black, will therefore be a color qualified class 630, having ID 1600. It would sort into a group with other color qualified classes of dog, such as red dog, and they would all appear before the big dog class, which is a size qualified class 632, having a higher ID number in this example, i.e., ID 1700.

When two details have the same class, then they are normally sorted based on their “placement order,” which is the order in which they were entered as details of their context in profile. Referring to FIG. 5A, color 606 will sort before size 610 because it appears before size as a detail of the class thing. For two qualified classes having the same class, ordering is determined not by placement order (in the preferred embodiment, qualified classes are usually referenced without being placed), but by the qualifiers: numbers as qualifiers sort before strings, and sort numerically with each other; strings sort next, and sort alphabetically; class-qualified classes sort next, and are ordered based on the class ID of the qualifier class; list-qualified classes sort last, and are ordered by applying the previous rules to their elements one at a time. Referring to the example of FIGS. 5A and 6, a qualified class red dog 645 would sort after a qualified class black dog 642 (and therefore have a higher class ID, as shown in FIG. 6) because both are color qualified classes, but the class ID of the qualifier black 608 is 600, where the class ID of the qualifier red 609 is 650. When classes are created or deleted, some or all classes may need to be renumbered in a manner that preserves the existing ordering.

The number assigned to a class per the current class numbering is called its class ID and in preferred embodiments is kept as the ID 410 of the class structure (see FIG. 4). The primary purpose of the class ID is to support the canonical ordering of the details of a detail (more below). Preferred embodiments also use the class ID to support an efficient subclass test: a class c1 is a subclass of a class c2 if and only if the class ID of c1 is greater than the class ID of c2 and less than or equal to the maximum class ID of any subclass of c2. Furthermore, because of the criteria by which the details of a detail are canonically ordered (see below), it supports binary searching through the details of a detail to locate those, if any, that are of a particular class. Finally, it supports other highly efficient search and matching algorithms that are useful, for example, in parsing English.

FIG. 4B shows a structure (as alluded to above) that may be used to represent classes. As shown, a class c has associated with it:

the largest class ID 423 of c or any subclass of c per the current class numbering. This is the class ID of the (direct or indirect) subclass of c with the largest class ID. By definition this is strictly less than the class ID of any sibling classes of c that sort after it. This is a field that's unique to classes, and used to speed up the subclass test in preferred embodiments. For example, imagine the test “Is a dog a mammal?” in the profile of FIG. 6. The class ID of dog 640 is 2300; the class ID of mammal 632 is 2000; the maximum class ID field of mammal is 2550, from the class red dog 645. Since 2300 is greater than or equal to 2000 and less then or equal to 2500, reasoning logic can deduce that a dog is a mammal. The preferred embodiment stores this field in the class structure, but other embodiments might store it, for example, in an external table indexed by class ID.

if c has one or more instances with instance indices, a structure 428, with a reference 424 in the class structure, possibly cataloguing all such instances (e.g., a vector of instances sorted by instance ID but allowing nulls for more efficient addition and deletion) but at least supporting both efficient location of numbered instances of c and efficient determination of all presently unassigned instance IDs for c. This supports the location of instances specified with an instance ID, such as 505 dog #1 in FIG. 5A; as discussed elsewhere, the preferred embodiment only assigns instance IDs when they're needed to resolve value references, rather than assigning them to every instance that's created. It points to all numbered instances, which generally will not be all instances. In the example, person #1 has a pet detail (which is an instance) that isn't numbered, so is not contained in the structure for the class pet. But its value is a pointer to an instance of dog—the existence of the value reference mandates that dog “Fred” have an instance ID, and therefore that it be in dog's structure. If dog “Fred” stopped being a value of anything, the instance ID, and therefore the reference in dog, could go away.

Keeping these as components of a class structure (in addition to the class, context, value, details, and instance ID components) would require that the structure of a class to be larger than that of an instance. As shown in FIG. 4B, the preferred embodiment implements the class structure as a strict superset (and, in programming language terms, as a subclass) of instances. The additional information with classes is useful only to KAP modules and to primitive routines that manipulate the profile; it is not directly accessed anywhere else. Making the class structure bigger has a collateral advantage: classes could initially be numbered 100, 200, 300, . . . , say, so that renumbering would almost always be either unnecessary or just locally necessary or profile-subtree-specific when a new class is created. In other embodiments, the maximum class ID can be stored in an array that is separate from the class structures, but this requires additional effort on class creation unless the array is sparse and therefore memory-inefficient.

In certain embodiments, the order of certain sibling classes (classes with the same immediate superclass) is, in many cases, critical to the “correct” canonical ordering of sibling details (details with the same context) that are instances of such classes. Examples are: ordinals (first, second, . . . ), certain subclasses of the class number (one, two, . . . ), certain subclasses of the class time (midnight, am, noon, pm), certain subclasses of the class month (January, February, . . . ), certain subclasses of the class day (Sunday, Monday, . . . , day 1, day 2, . . . ), certain subclasses of the classes am and pm (1 am, 1.5 am, . . . ), and certain subclasses of the class step (step 1, step 2, . . . ). If a profile is created with such subclasses in other than their natural order, then other data in the profile will have a canonical ordering that's not natural, and reasoning about it will be much more difficult. If subclasses representing the ordinals are not in their natural order, then classes qualified by them won't be either. For example, if the ordinals appear in the profile in the order second, third, first, then the step details of a recipe would appear in the KAL representation in the order second step, third step, first step. The semantics of some classes is closely related to their relative order, so preserving that is an important aspect of profile design.

Preferred embodiments use classes negation and name to be the first two subclasses of class thing, as a performance enhancement.

Preferred embodiments implement a common class tree. Such a common class tree may be standardized and evolve as such for example through an appropriate standards body. Appendix A (attached) provides an exemplary common class tree, in this case represented in KAL notation.

### Names

A “name” is a detail of a class called “name”: in the class tree of FIG. 6, derived from the exemplary profile of FIG. 5A, a name would be an instance either of class name 604, or of class synonym 605, a subclass of name. When a name has a value 406 that is a string, that string represents the “spelling” of the name. In FIG. 5B, the name detail 509 has as its value the string “Fred,” the spelling of the dog's name.

A name with a spelling typically corresponds to some “natural name”: an English word, a proper name, an acronym, etc. In FIG. 5B, again, the dog 505 has as its name the name detail 509, representing the dog's proper name, properly capitalized. The spelling should reflect the usual capitalization of the natural name; for example, the spelling for a proper name like John or Vermont should have the first letter in upper case and the remaining letters in lower case.

Preferred embodiments map from a string to (a) every name with the same spelling as the string, capitalization included, and (b) to every name with a value that is a list, one of whose elements is an equivalent string, capitalization included. Certain embodiment perform such mapping using a hash table like the one described above.

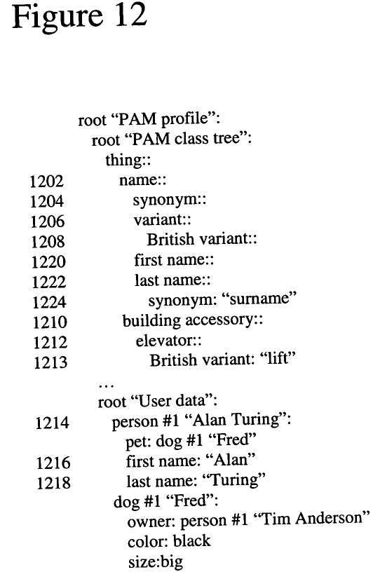

A detail may have any number of details of class “name.” As shown in FIG. 12, a small portion of a profile, the person 1214 has an implicit name detail “Alan Turing” specified on the detail line. In addition, there are separate first name and last name details 1216 and 1218, each with a string value. As shown at 1220 and 1222, first name and last name are qualified subclasses of name, so this person detail has two additional details of class name. A class may have any number of synonym details, and a word class may have any number of variant word details that identify variant spellings (see below). Again referring to FIG. 12, the class elevator 1212 has a British variant detail 1213 giving the equivalent word in that dialect of English. The last name class 1222 has a synonym detail 1224; its value, “surname,” is taken to be a synonym for last name.

### Contexts and Details of Details

In most cases, there seems to be a “natural” context for a detail d: another detail representing something that the thing represented by d “has”. For example, the pet detail 504 in FIG. 5A is naturally a detail of the pet's owner, in the same way that the owner detail 508 is naturally a detail of the thing owned. A month would often have a year has as its natural context. A province would typically have a country as its natural context. An employee detail, which might either have details as a person or have a person value, would typically have an organization as its natural context. The natural context, if one exist, is found through the English phrase describing the detail, or its equivalent qualified class. Thus, in FIG. 5A, the dog 505 was initially entered as “my big black dog,” which produced the qualified class dog [color:black, size:big]. In converting this to an instance of the head word class dog, the qualifiers were placed in their natural context: the instance of dog being created, with a color and a size detail. Similarly, the word “my” in the expression “my big black dog named Fred” established to reasoning logic that some detail being created would have the person speaking as its natural context—in this case, the pet detail 504. In some cases, the preferred embodiment could create the dog as a detail of its owner, rather than making the relationship be the detail with a natural context. This will often be determined by the form of the input given by the user, but in the preferred embodiment, a “relationship” detail, such as pet, cousin, daughter, or employee, has as its natural context the other end of the relationship; similarly, descriptive details always have as their natural context the thing described. For those details that don't have such a natural context, e.g. certain persons, animals, organizations, companies, utilities, universities, publications, and medications, the systems has “high-level contexts,” usually as details of the root context, that serve the purpose; thus in FIG. 5A both the person and the dog are details of the context 502, root “User data.”

When a detail representing a thing x of class clx has a detail d (i.e., a detail reference by details vector 408) representing a thing y of class cly, it can usually be said that “x has a cly”, that “d represents a/the cly of x”, and that “y belongs to x”. Thus in FIG. 5A, the person 503 has a pet (504), the dog Fred (505); that pet belongs to (has as its owner) the person 503; the detail 506 represents the color of Fred. If, in addition, d has a value 406 representing a thing z, it can usually be said that “x has a cly, namely z”, that “a/the cly of x is z”, and that “x is a clx with (having, that has) cly z”. Again in FIG. 5A, the person 503 has a pet, namely Fred; Fred's size is “big”; he is black, or less idiomatically, he has the color black These relationships may be used by the KAP/KAL logic 218 so that the logic may convert a portion of the profile into NL output to a human user.

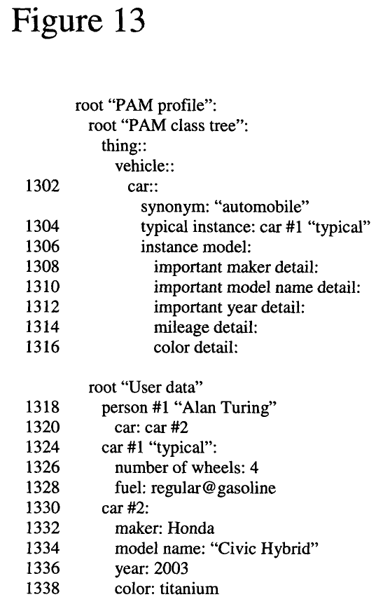

In preferred embodiments, a detail should not have details that can be easily inferred by logic. Thus, for example, a detail representing a particular thing should not itself have details that specify what could be determined from a detail representing a prototypical or typical instance of the same class (“typical instances” are discussed below). Another way of saying this is that the details of a detail should generally represent distinguishing features or characteristics relative to a typical instance. FIG. 13 shows a simple portion of a profile chosen for illustrative purposes. The portion of the profile includes the class car 1302. It has a typical instance detail, 1304, which in turn has as its value a specific instance of the class car, 1324. That detail has, in this example, two details, 1326 and 1328; the detail 1326, number of wheels, has value 4. Unless PAM knows that a particular car has an a typical number of wheels, reasoning logic will permit it to deduce from the typical instance that it probably has four wheels, so will need four new tires.

It is not uncommon for two sibling details to have the same class; for example, almost anything could have multiple names, a person could have more than one computer, and a year has twelve months. It is even possible for sibling details to have the same class and value, where that makes sense. This helps illustrate the distinction between instances and classes in this respect: you can't have two subclasses with the same class and value (because they would represent the same class, and that's not allowed), but you can have two instance details of a context with the same class and value—among Richard Burton's numerous wife details, there are at least two with the value ‘person “Elizabeth Taylor”’.

Preferred embodiments maintain a canonical ordering of the details of a detail in order to make reasoning logic more efficient (allowing, for example, the use of a binary search to locate details of a particular class), and to facilitate comparisons between the details of similar contexts, both programmatically, and by examining the KAL representation of the profile. A canonical ordering of the details of a detail is maintained as follows:

overall, in class ID order, that is, in order of ascending class IDs 422 of their classes; each class in the exemplary class tree of FIG. 6 is shown with its class ID in parentheses. The tree in FIG. 6 is in canonical order.

within details that have the same class, in order of creation during loading or subsequently, except that there are special ordering rules (see below) for sibling classes that have the same class.

The ordering is maintained in the vector 408 of the detail structure. In FIG. 5B, entities 506-509 represent the elements of the details vector 408 for the dog Fred 505, in their canonical order based on the class indices shown in FIG. 6.

Sibling primary word classes are kept in order of creation during loading or subsequently, but, where the context is unplaced-word (see below), then in alphabetical order per their spellings. Sibling secondary word classes are kept in order of creation during loading or subsequently.

Sibling qualified classes that have the same class (i.e., that have the same qualifier role) are kept in the following order. First come all those with numbers as qualifiers, in numeric order per the qualifiers. Then come all those with strings as qualifiers, in alphabetical order per the qualifiers. Next come all those with classes as qualifiers, in class-ID order per the qualifiers. (It is difficult to satisfy this ordering rule when at least one of the qualifiers q does not yet have a class ID at the time a new sibling qualified class is inserted into the details vector, say because q is a subclass of the qualified class of which it is the qualifier, or when the position in the class tree 204 of one or more of the qualifiers is changed due to correction by KAP of the context of a detail misplaced by a developer.) Finally come all those with lists as qualifiers, in an order determined by applying these rules for sibling qualified classes to the first element and then to subsequent elements as necessary to determine the order.

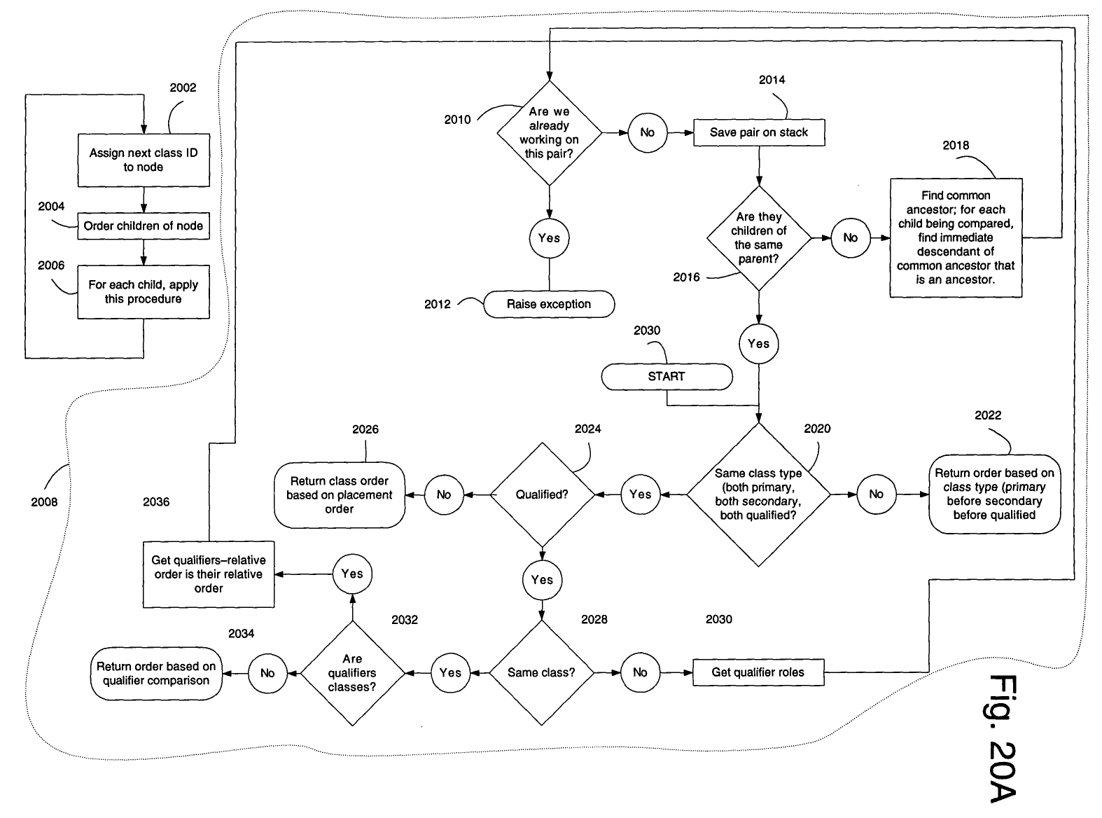

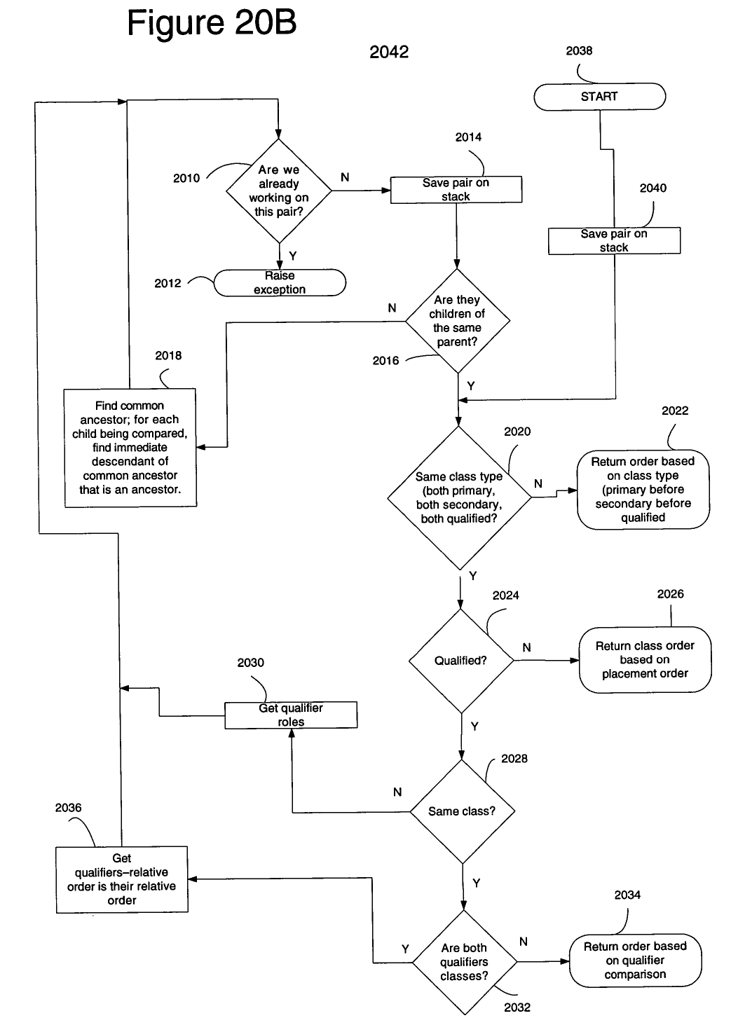

The assignment of class IDs by the preferred embodiment is illustrated by the flowcharts in FIGS. 20A and 20B. The basic procedure is shown in steps 2002, 2004, 2006, and 2008 of FIG. 20A: starting with the detail for the class “thing” at 2002, assign the next available class ID to it in 2004. Then, in step 2006, put the subclasses of the class into canonical order, as discussed below. Finally, in 2008, apply this procedure to each of the subclasses in turn—that is, the procedure is recursive. It should be clear that the difficult task is putting the subclasses of a given class into their canonical order: as described above, this is most easily expressed in terms of the class IDs, which haven't been assigned yet.

To put the subclasses of the class into canonical order, the preferred embodiment sorts them using a standard algorithm, such as quicksort, that uses pairwise comparisons of the elements being sorted. The preferred embodiment provides a procedure as illustrated in the flowchart 2042 of FIG. 20B to determine the relative order of two subclasses. This procedure is called by the standard sorting algorithm.

We enter the procedure at 2038, beginning with step 2040; on entry, we have two classes that are subclasses of the same class. As discussed later, it's necessary to keep a stack of all the pairs currently being worked on. Having initialized that, the algorithm moves to the decision 2020: are the two classes of the same type, that is, both primary, both secondary, or both qualified? This is decided by comparing the class references 402 of the two input classes: for a primary class, 402 will be the class “primary word class”; for a secondary class, “secondary word class”; for a qualified class, a subclass of “qualified class.” If the two class references are equal, the input classes have the same type; if they are not equal, then if neither is equal to either primary word class or to secondary word class, they are the same (qualified) type. If the input classes are not of the same type, the procedure returns at 2022: the rules for canonical ordering state that primary classes are sorted before secondary classes, which in turn are sorted before qualified classes.

If the class types are the same, then we proceed to the decision 2024. If the input classes are not qualified classes, as discussed above, then the procedure returns at 2026: the relative order of the classes is determined by their “placement order,” that is, the order in which they were encountered by KAP. In FIG. 5A, for example, the class black 608 appears before the class red 609, and that defines their relative positions in the canonical ordering. As shown in FIG. 6, the class ID for black 608 will be smaller than that for red 609.

Returning to decision 2024, the other branch is taken to decision 2028 if both classes are qualified. In that case, at 2028, we first look at the class references 402 of these qualified classes (for clarity, referred to as their implementation classes). For example, in FIG. 5D the implementation class of the class “black dog” 642 is “color qualified class” 630. If the implementation classes differ, then the relative order is the relative order of the qualifier roles—that is, the relative order of “black dog,” a color qualified class 630, and “big dog,” a size qualified class 632, is determined by the relative order of the qualifier roles color 606 and size 610. At step 2030, we obtain the roles, which as discussed above are stored in the value reference 406 of the implementation classes, then proceed to decision 2010, described below.

At 2028, if the implementation classes are the same, we move to decision 2032. Recall that qualifiers can be strings, numbers, classes, or lists. If the qualifiers (stored in the value reference 406 of the input classes themselves) of the two classes have different types, their order is determined as described above, and we return at 2034. If the qualifiers are both numbers or both strings, their order will be numerical or alphabetical, and we return at 2034. If the qualifiers are both lists, we compare the elements pairwise in order until a difference is found, and return at 2034.

If both qualifiers are themselves classes, then the relative order of the two initial classes is the same as the relative order of the qualifiers. The order of the classes “red dog” 645 and “black dog” 642 is the same as the relative order of their qualifiers, red 609 and black 608 respectively. At 2036, we obtain the qualifiers, and proceed to decision 2010.

Decision 2010 is used to detect a case described in more detail below. The algorithm described here maintains a stack of the pairs whose comparisons it is currently trying to obtain. That is, if it started by comparing “red dog” and “black dog,” it will then reduce that to the comparison of “red” and “black.” It must remember that it was already working on “red dog” and “black dog” to avoid infinite recursion. At step 2010, if the algorithm is already considering the new input classes, it raises an exception at 2012—the class hierarchy as defined cannot be numbered.

If not, at step 2014 the new classes are saved on the stack. Then, at decision 2016, the algorithm determines whether the classes are siblings. If they are, it proceeds to decision 2020, described above, and compares them. If not, then their relative order is same as the relative order of the pair of ancestors of the two classes that are siblings. That is, the relative order of black 608 and big 612 is the same as the relative order of color 606 and size 610, since color and size are both children of thing 602. The algorithm goes to step 2018 to obtain the sibling ancestors, then returns to decision 2010.

The preferred embodiment uses a number of auxiliary data structures to implement this algorithm. In particular, the representation of prototype classes during the KAP process includes extra information, such as placement order, that is not needed once everything has been loaded and the classes have been ordered. This algorithm, in addition to maintaining a stack of the pairs it's currently working on, maintains a hash table (the key being the concatenation of unique IDs associated with each prototype class) storing the results of such comparisons, in order to avoid the potentially substantial overhead of executing them several times during a sort operation.

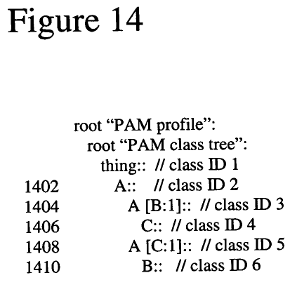

As mentioned above, and as shown in FIG. 14, it is possible to generate a syntactically correct KAL representation of a profile that cannot actually be constructed, because the resulting class tree cannot be numbered and ordered in a consistent way. Because the preferred embodiment allows manual editing of the profile, it must also recognize and reject such cases, as shown in FIG. 20. The class definitions in this example are entirely abstract. The class 1402 has two qualified subclasses, 1404 and 1408. The qualifier role of the subclass 1404 is class 1410, a subclass of 1408; the qualifier role of the subclass 1408 is class 1406, a subclass of 1404. The comments on each class line (preceded by “//”) show class IDs assigned to these classes. But with those assignments, the class 1404 should be sorted after the class 1408, because the class ID of its qualifier role (class 1410) is 6, while the class ID of class 1408's role (1406) is 4. With that sorting, the classes 1406 and 1410 will receive new class IDs, which would force 1404 and 1408 to sort in the order shown in the figure. The algorithm of FIG. 20 will detect this as follows: it begins by attempting to determine the relative order of the classes 1404 and 1408. Since they have different qualifier roles, that is the same as the relative order of the roles: the class B 1410 for class 1404, and the class C 1406 for class 1408. The sibling ancestors of B and C are the classes 1408 and 1404, respectively; since these are already on the stack used in FIG. 20, the algorithm will terminate with an exception.

Note that the order of detail creation during loading generally reflects either: (a) the original position of the detail in a KAL file set detail outline, if that is how it originated; (b) when KAP transformed it from a “protodetail” to a detail (see below), if that is how it originated; or (c) when it was dynamically created, if that is how it came to be. However, later manual editing of a KAL file set can obviously invalidate the original ordering.

This canonical ordering of details has several purposes. First, it supports efficient “matching”, by algorithm or by eye, of “comparable” sets of details. Because details have the same relative orderings, one can easily put the details of two similar contexts side by side to see differences quickly; algorithmically, one can simply iterate through the two sets of details, identifying additions, deletions, and changes: details of the same class will always be in the same relative position. Second, it groups together the details of a particular class as well as of related classes, again supporting efficient processing by algorithm or by eye. Third, it appropriately orders sets of details that have qualified classes that are the same except for the number in a numeric qualifier, for example plan 1 before plan 2, step 1 before step 2, and marriage 1 before marriage 2, again supporting efficient processing. Finally, it supports an efficient binary search for all details of a detail that are of a given class, based on the class ID of the class; this is particularly efficient when the details of a class are maintained in a vector structure.

For a context with a detail d to which details might be added, either d itself or the value of d (perhaps created for the purpose) might actually get the details. For example, in

person #39 “Mary Smith”:

car #77:

maker: manufacturer #57 “Honda”

model name: “Civic”

year: 1998

the detailed car is a detail of the person. This has the advantages that its context is “natural”, that it is simpler notationally, and that it is economical of memory. Alternatively, in

person #39 “Mary Smith”:

car: car #77

car #77:

maker: manufacturer #57 “Honda”

model name: “Civic”

year: 1998

haver: person #39 “Mary Smith”

the detailed car is the value of a car detail of the person. This has the advantages that it is less context-dependent (assuming that the context of car 77 is some high-level context whose details might be very valuable things) and is sharable and/or transferable as a value. In general, wherever the system allows or expect one of these possibilities, it should also allow or expect the other. Depending on the software creating the profile, and on the exact nature of the user's input, either form may be found; when the system is looking for details of my car, it needs to consider the value of my car detail as well as details directly contained under it.

### Values

A “value” is English-based and specifies a thing typically in a way that is relatively context-insensitive and general. A value can be a number, a string (e.g., “Tim”), a reference to a class (e.g., person), a reference to an instance (e.g., person #51 “Tim”), or a list of things that values can be (e.g., low, medium, high). As indicated above, a value of a detail d typically represents what d represents but often in a less context-dependent and more general way.

On implementation platforms like NET, numbers and strings are represented in values as “boxed” objects; for space efficiency, some embodiments maintain vectors or hash tables of small integers and common strings, to reduce the number of objects created. The preferred embodiment implements lists as vector structures.

A value is to be interpreted within some common-sense reasoning domain (more below) according to the class of the detail of which it is a value. Some classes allow values that require sophisticated reasoning algorithms to interpret and make use of. For example, time details may have values corresponding to such English phrases as “Tuesday afternoon or Wednesday morning”, “three weeks before my brother's second marriage”, etc. Thus, unlike conventional databases, where values are typically formatted for simple arithmetic and symbolic computations, values in profiles of preferred embodiments often need significant interpretation whenever they are used.

Under preferred embodiments, for every individual reference to an instance r in the value (406) of a detail d (400), there will be a corresponding back reference; that is, a detail of r whose value is either a reference to d or the context of d. In general, back references from classes are not kept, but they are for: inverse relations of classes, alternative values, classes that are qualifiers of qualified classes (except in the case of certain qualifier roles like quantity), details of typical instances, etc. Some embodiments of the invention provide a mechanism that allows the designer of the profile to specify an additional set of relationships for which back references are kept from classes: a drug in the profile might have side effects details, and for certain applications it is important to provide links back from the side effect to the drugs that can cause it. Back references are automatically maintained.

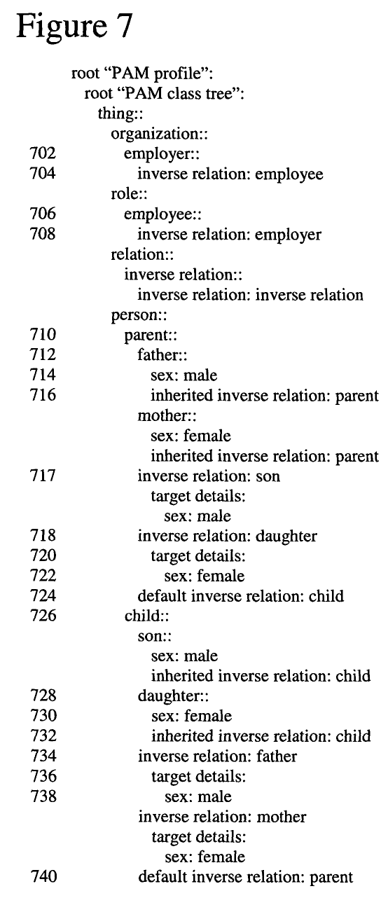

Automatic maintenance of back references is implemented by the preferred embodiment in software that manages access to the profile: as part of changing the value of a detail d, the software will find and remove references (in the case where d's value is a reference, and is being changed), and create new references (when d's value is becoming a reference). This ensures that the profile will remain internally consistent: when a detail d is deleted, for example, any detail referencing d in its value can be updated automatically, by following the references in details of d. The class of an automatically created back reference is determined by reasoning; some embodiments use a method illustrated by the exemplary profile in FIG. 7.

The simple case of the employer/employee relationship is shown in 702-708: the class employer 702 has an inverse relation detail 704 whose value is a reference to the class employee 706; in turn, the class employee has an inverse relation detail 708 whose value is a reference to the class employer. When a detail d having class employer has a detail e assigned to its value, the detail e will automatically be given a back reference of class employee, based on the inverse relation detail of the class employer.

A method of reasoning about the more complicated case of parent/child relationships is shown in 710-740. If the software knows nothing about the sex of either party, then it can only create details of class parent and child; the class parent 710 has a default inverse relation detail 724 whose value is the class child 726. Because the class default inverse relation is a subclass of inverse relation, it is the case that the class parent has at least that as an inverse relation detail. However, it has two additional inverse relation details; the second, 718, has as its value the class daughter 728, and also has a target details detail 720, with a single detail 722, sex: female. The following reasoning applies in the preferred embodiment. A father detail f is given as its value a detail pf. The inverse relation detail of the class father is the inherited inverse relation detail 716, with value parent; the logic will therefore find the class parent 710 to determine the class of the back reference created in pf. In parent, it finds three inverse relation details 717, 718, and 724. The first two have target details details; the “target” in this usage is the context of the father detail f. If that detail has a sex detail with value female, or if reasoning can determine in some other way that it represents a female, it will match the target details 720, and the inverse relation daughter will be selected. If the context of the father detail f has no sex detail, then the default inverse relation 724 with value child will be selected.

Thus, the assertion by the user, or in the profile, that “Joe has a daughter, Emma” can, in addition to creating a daughter detail for Joe, automatically create a father detail for Emma. This makes reasoning about relationships of all kinds significantly faster and easier; if, later, the user has lost touch with Joe and wants him removed from the profile, the logic will detect that the detail representing Emma must either be updated, to remove the father detail, or also removed in its entirety, thus preserving consistency in the profile.

There are four cases of back reference.

1. Where the value of d is a reference to r and where the class of d has an “inverse relation” detail ir. In this case, r will have a (back reference) detail whose class is the value of ir and whose value is a reference to the context of d. This reference/back reference correspondence is symmetric. Therefore, the value of ir (a class) must have an inverse relation detail whose value is a reference to the class of d. A class may not have more than one inverse relation detail. Examples of inverse relations are the class pairs: husband/wife, cousin/cousin, employer/employee, maker/product, calendar time/calendar action, and inverse relation/inverse relation. As discussed above, more complicated reasoning is supported for relationships such as father/daughter/parent/child.

2. Where the value of d is a reference to r but where the class of d has no inverse relation detail. In this case, r will have a (back reference) detail whose class is “haver” and whose value is a reference to the context of d. (Note that a haver detail of a context x has, as its value, a reference to another context y that has a detail with a value that is a reference to x.)

3. Where the value of d is a list, one of whose elements is a reference to r. In this case, r will have a (back reference) detail whose class is “top-level list inclusion” and whose value is a reference to d. Note that if more than one of the elements is a reference to r, there will be that number of list inclusion back references.

4. Where the value of d is a list and case 3 doesn't apply. In this case, r will have a (back reference) detail whose class is “embedded list inclusion” and whose value is a reference to d. Note that if the value of d has more than one reference to r, there will be that number of value inclusion back references.

In cases 1 and 2, the reference/back reference pair may together be referred to as “cross references,” in part because of the fact that, in a diagram, arrows representing the corresponding references would likely cross.

In all the cases, there could be unusual situations where the system is unable to determine which particular back reference was created to correspond to a given reference. Therefore, it is risky to put details on back references and to delete individual back references. (In some embodiments, the system keeps, in the unusual situations, special details on back references sufficient to unambiguously determine the corresponding reference.)

When a detail r is deleted that currently has references to it in one or more values, the references are automatically updated, as follows. For a value of a detail d that is a reference to r, d is made to not have a value. For a value of a detail d that is a list containing one or more references to r (not necessarily as elements), each such reference is replaced by a reference to a special detail named “deleted detail”, which will then have a value inclusion back reference to d. (To guard against performance problems due to build-up of large numbers of deleted detail back references, the system might not keep all, or any, back references on the detail named “deleted detail”, say by having it be a class.)

### Instance Indices

An instance identifier (ID) 410 is a positive integer. In the case of a detail that is a class, the instance ID is the class ID 422 (which can change when classes are created or deleted). Otherwise, the purpose of an instance ID is to support identification (by software and by people) of references to the detail in KAL, as with the reference 504 to the detail 505. For an instance, the instance ID is assigned when a reference to the detail is first used in a value or is needed for KAL-file journaling, and it must be unique among all instances in the profile that have a particular class; for humans, it is important that this assignment remain stable over evolving versions of the profile. A reference to an instance in a KAL representation of a value is derived from the KAL representation of its class plus its instance ID.

When a profile is (re)saved in a KAL file set, the preferred embodiment eliminates no-longer-needed instance indices, to save space and processing time and to make the text more readable by humans.

### Descriptors

In some embodiments, the knowledge base includes descriptor details to describe either the things represented by certain details or the details themselves. The preferred embodiment enforces a restriction that a given detail d may have no more than one descriptor detail (that is, a detail of class “descriptor”) dd; the value of dd in the preferred embodiment can be a reference to a single descriptor, or a list of references to descriptors.

A descriptor usually corresponds to an English adjective (e.g. typical), to an English adjective with an adverbial modifier (e.g. generally happy, not managed), to a generic English noun (e.g. template), to a generic English compound noun, to a generic English prepositional phrase (e.g. under construction), or to a generic English verb phrase (e.g. likes pizza). Under certain embodiments, the vocabulary, grammar, and usage of descriptors may be prescribed by a standards body, e.g., the same body that might maintain the standardized class tree, referred to above and attached as Appendix A. The standardized use of a standard set of descriptors gives them far more utility than unconstrained use of arbitrary constructs: reasoning logic will in general have much less success in dealing with descriptors outside the standard set that it was constructed to take advantage of.

When a detail d has a descriptor detail with the value e, then we say that “d is described as e.” Thus, a dog with a descriptor detail with the value “happy” is described as happy; an instance with a descriptor detail with the value “primary” is described as primary.

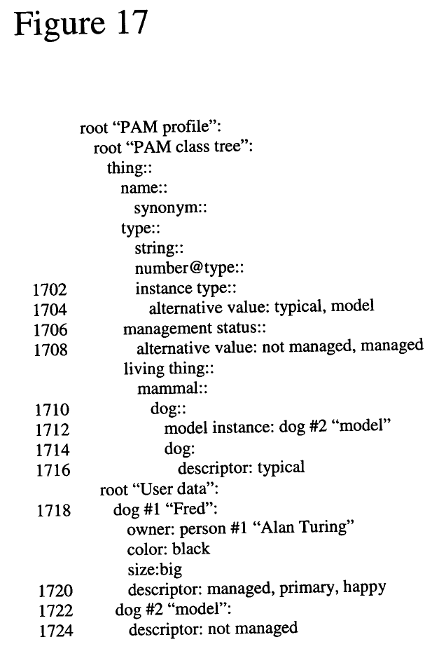

FIG. 17 contains exemplary uses of descriptors, and shows some alternatives that may be used in some embodiments. It deliberately omits many class definitions and instances that are not relevant to this discussion.

Item 1702 is the definition of the class instance type, which has a single detail 1704 of class alternative value. In the preferred embodiment, this defines a restriction on descriptors: a detail d may not have more than one descriptor from the set of alternative values here defined. That is, it may be described as “typical” or as “model,” or as neither, but not as both. The class dog 1710 shows the use of a single descriptor: it has as a detail a dog instance 1714, with a single descriptor 1716, typical.

The dog 1718 shows the use of a list to store multiple descriptors for a single detail. Item 1720 is a descriptor detail with a list value, containing the three descriptors “managed,” from the set of alternatives 1708, and “primary” and “happy,” not otherwise defined. In some embodiments, the “primary” descriptor might be used to identify a primary instance, as discussed above, although the preferred embodiment uses other logic to make this identification. As discussed below, the “managed” descriptor, in conjunction with the alternative “not managed,” as used at 1724 for the model dog 1722, is used in the preferred embodiment to identify, respectively, details that are being managed by the PAM system, or that should not be managed by it.

A class that can be the qualifier of a qualified class can typically also be used as a descriptor. Thus one might, as with 1716, use “typical” as a descriptor, rather than, as in the preferred embodiment, using it as a qualifier to identify a typical instance of a class: there is logical equivalence between having an instance described as typical, and having an instance of the class “typical instance”; different embodiments may choose different methods, though of course a robust implementation will maintain consistency by using one method or the other exclusively.

Not every descriptor of a detail d actually qualifies the thing represented by d or d itself; in many cases, the descriptor just describes it non-restrictively. In FIG. 17, 1720 includes a descriptor “happy” for the dog 1718, something that would generally be taken as a description of that particular dog rather than a restriction that might be used to form a class.

Relationships

One way to look at a detail is in terms of its relationships with its various components. For a detail d with class cl, context co, value v (when there is a value), and details d1, d2, etc.:

d is a cl (the relationship between d and its class)

co has d (the relationship between d and its context)

d is v (the relationship between d and its value, if any)

d has di, for each di (relationships between d and its details)

The is-a relation may also be read “is an instance of”. The has relation, as we have discussed above, is very abstract and needs to be interpreted as a function of the classes of its arguments. (Note that “cl of c” implies a relationship in which the of relation may be thought of as being derived from the has relation, hence sharing its abstraction.) A key aspect of dealing with relationships is, in fact, moving from abstractness to specificity through interpretation.

Another way to look at d, when there is a value, is as a cl relationship between co and v, which can be expressed as “the cl of co is v”. We call such a relationship a “triple” in recognition of the attribute-object-value triple of classical AI, to which it is equivalent.

In preferred embodiments, the following

block:

color: red

would correspond to the classical AI triple

(color block-1 red).

It should be observed here that the has/of relation abstraction in profile relationships is also equivalently present in classical AI triples. Thus, in either case, such relationships must be interpreted with respect to the classes of their components, including the relation itself.

One approach to reasoning with relationships is to apply axioms defining the relations. Under preferred embodiments the style is more one of common-sense reasoning, as described above.

### Instance Models, Typical Instances, Examples, etc.

A class c may have “instance model” details, “typical instance” details, “example” details, etc. with values that refer to instances of c. An “instance model” for a class c may be used as a basis (template) for filling in details of a brand-new instance of c. A “typical instance” (or, less usefully, an “example”) of a class c may be used as a basis for determining approximate values of certain details of c when specific or absolute information is absent. FIG. 13 shows both. The class car 1302 has a typical instance detail 1304, whose value is a “typical” car, 1324, and an instance model detail 1306, with several details but no value. The typical instance of car 1324 has, in this simplified example, a number of wheels detail, with value 4, and a fuel detail, with value regular@ gasoline, meaning that the typical car takes regular, where the “regular” in question is a subclass of gasoline. If the user asks what kind of fuel his car takes, simple reasoning logic can examine the car itself (1330 in this example) for a fuel detail; finding none, it can look for an applicable typical instance detail in the class car, and reasonably assume the value obtained from that.

The instance model detail 1306 lists five pieces of information that PAM (or some other application) might try to elicit when it found out about a car. The “important” details 1308, 1310, and 1312 are required by PAM in order to manage the car. The details in an instance model indicate information that PAM has some intelligence about managing; the class of the detail in the instance being managed is obtained by stripping off “detail,” and the “important” qualifier if present, to obtain a (possibly qualified) class name. Thus, PAM would attempt to obtain from the user the manufacturer of his car, and would store that as a maker detail (obtained by removing “important” and “detail” from “important maker detail”) of the car. Similarly, the model and year are required for PAM to manage it; the color is particularly useful if there are multiple similar cars in the profile, and the mileage is of course useful for many management functions for a car. The specific car 1330 has its important details 1332, 1334, and 1336 filled in, and also has a color detail 1338, but nothing else. Some embodiments may display a dialog prompting the user to fill in important details as soon as an instance is created; the preferred embodiment will ask the user in a managed conversation, but will not require that he provide the information before continuing with other functions in the program.

### Actions

An “action,” such as “fly,” is a subclass or instance of the high-level class action. All English verbs except “to be” correspond to actions, as do many English nouns, particularly those derived from verbs, such as “meeting.” Actions are used to represent events, activities, tasks, past events, plans (for future events), steps of procedures, procedure executions, “threads”, the intension (meaning) of verb phrases and of some noun phrases, etc. Actions may be past, present, or future (planned). Actions can have many distinct kinds of details; indeed, the complexities of reasoning about and carrying out actions stems largely from the number and variety of details that might be involved.

A “procedure” is a model of how to carry out (execute) an action. In preferred embodiments, procedures are written in English and are broken down into steps. (Cookbook recipes are good examples of this kind of procedure.) (As used herein “procedure” should not be confused with compilable language procedures in languages such as Pascal).

Actions can have many distinct kinds of details. Indeed, the complexities of reasoning about and carrying out actions stems largely from the number and variety of details that might be involved. Here are some classes of details of actions together with some associated English words:

agent—“by”

co-agent—“with”

participants

object, patient—“of”

time—“at”, “in”, “on”, “before”, “after”, “when”, “until”, “since”, “later”, “earlier”, “previously”

location—“at”, “in”, “on”, “before”, “after”, “by”, “where”, “above”, “below”, “over”, “under”, “beneath”

origin—“from”

goal—“to”

beneficiary—“for”

topic—“about”, “of”

means—“with”, “through”

method—“by”

exclusion—“without”

direction—“towards”

trajectory—“through”

negation—“not”, “never”

modality—“may”, “can”, “must”, “want to”

quantity—“often”, “twice”, “repeatedly”, “the”, “some”

recurrence—“again”

speed—“quick”, “slow”

frequency—“always”, “frequently”, “often”, “seldom”

continuity—“continual”, “ongoing”

amount—“a lot”, “a little”

duration—“long”, “short”

quality—“well”, “poorly”, “good”, “bad”

reason—“because”, “since”, “why”

condition—“if”

countercondition—“unless”

consequence, implication—“so”, “thus”

counterimplication—“but”, “though”, “although”, “however”, “even”, “albeit”

currency—“past”, “current”, “present”, “planned”, “future”

step

state

Some of these classes may be regarded as dimensions of what might be described as “action space”. That is, one dimension, or aspect, of an action, is the person or thing performing the action, the agent; another is the time at which the action took place, or will take place; still another might be the location of the action. Other classes described above are specific to certain actions: although a flight might have an origin (“from”) and destination (“to”), those classes would not generally apply to the action of reading a book.

### Times, Calendars, and Schedules

A “time”is a class corresponding to an English word, number, or phrase that represents a time. Time details often have times as values, and the time domain common-sense reasoner is very capable of reasoning with times. Here are some examples of times as expressed in English: June, 10 am, tomorrow evening, some evening next week.

A “calendar” is a detail of class calendar that has details of class year, which in turn have details of class month, and so on through days, times-of-day or hours, minutes, and seconds, as appropriate. In other words, a calendar has years, years have months, months have days, etc., each of these being a detail whose class is an appropriate qualified class. (Year, month, day, etc. are all subclasses of the class time.) Calendars may, in the future, allow time divisions other than those described above, e.g., for weeks, mornings, afternoons, and evenings.

Any time detail in a calendar, in addition to possibly having time details at the next level of granularity, may have action details (details of class action). Indeed, calendars are typically “expanded out” into more granular times only to the extent needed for the action details they contain. More formally, a calendar will typically have a particular time detail only if that time detail will have in its sub-tree at least one action detail.

With the way calendars are organized and with the way details are canonically ordered, it is quick to find in a calendar the time detail closest to a given time. Also, in a pre-order traversal through a calendar subtree, time details will be visited in chronological order, which is useful, say, for carrying out actions in the calendar in scheduled order.

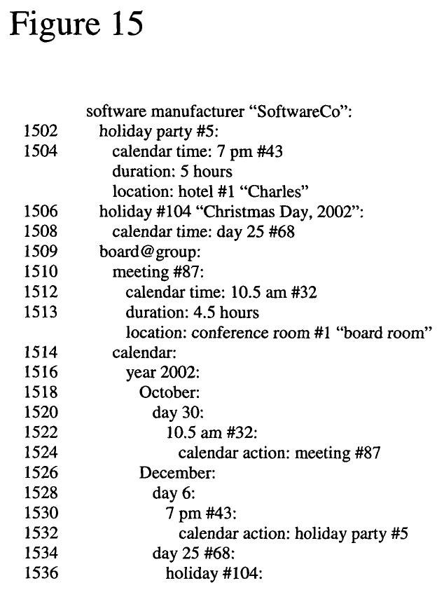

FIG. 15 shows an exemplary calendar for the board of directors of a software company. The board 1509 has a calendar detail, 1514, with a detail 1516 for the year 2002. (The class of the year detail 1516 is “year 2002”; it is a subclass of year, qualified by the number 2002. Similarly, the time detail 1522 has as its class “10.5 am”; it's a subclass of the class “am,” representing times in the morning, qualified by the number 10.5, half past ten.) The year in turn has details 1518 and 1526 for the months October and December, respectively; on October 30 (1520), at 10:30 AM (1522), there is a meeting scheduled (1524). The calendar action representing the meeting on the calendar has as its value the detail actually representing the meeting, with additional details such as the expected duration and the location. As discussed above, the meeting also has a back reference 1512 corresponding to the calendar action detail; were PAM managing calendars for members of the board, similar back references from the meeting would correspond to its presence on each of their calendars.

The calendar also shows a holiday party 1502, scheduled for 7 PM on December 6 1532, and shows a holiday on December 25, 1534 and 1536. As discussed above, the calendar's representation is sparse: it includes only entries that are needed to represent events. The canonical ordering of details puts events on the calendar into chronological order, making it easy to find the next event, any events occurring on a certain date, and so on.

A profile may include many calendars: for the system itself, for each user, and for various other persons, groups, and organizations. Calendars are structurally efficient at all sizes, from very small to extremely large. A system or personal calendar could well contain thousands of actions.

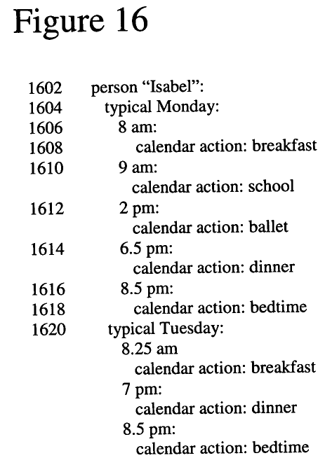

A time detail in a calendar is sometimes referred to as a “schedule.” Thus, there can be schedules for years, months, days, etc. “Typical schedules,” as shown in FIG. 16, are important for scheduling actions. A person, for example, might have (as details) typical schedules for each day of the week and for holidays, to guide selection of time slots by scheduling operations in the time domain common-sense reasoner. In FIG. 16, the person 1602, a young child, has a typical Monday with breakfast 1608, school at 9 1610, ballet at 2 1612, dinner at 6:30 1614, and bed at 8:30 1616. She doesn't go to school on Tuesdays, so her typical Tuesday 1620 is much simpler. The availability of a typical schedule, as with other typical instances, eases many reasoning tasks: if the child's parent is traveling on the West Coast, and wants to be reminded to call home before bedtime, bedtime can be found from the typical schedule, rather than being specified for every day on the calendar. Scheduling the call of course requires further reasoning based on the child's location, the parent's location, and time zone differences between them.

Calendars are used and manipulated by scheduling operations in the time common-sense reasoning domain.

### Classes

As discussed above, classes in the system are based on words and phrases from a natural language such as English. Although the exact meanings of specific words are not represented directly by the class hierarchy (“red” is a “color,” but the exact meaning either of color as a concept or of a particular shade is not captured by this relationship), their relationships, and the structure of qualified classes, provides significant power to reasoning logic.

In a conventional programming system, the name of a class serves merely as an identifier, even in those cases where it's accessible (and for many languages it is not once the source code is compiled or otherwise transformed). Here, the name of the class, particularly for a qualified class, maps directly into the structure representing the class, permitting the system to reason about the class in useful ways. As shown in FIG. 5D, the class representing black dogs has as its name “black dog,” and is represented by a structure preserving the semantics of that phrase: the class detail 560 has as its value a reference to the class black, and as its class a reference to the class “color qualified class.” The class “black dog” is in a sense self-declaring: the use of its name produces a class representing dogs whose color is black, and programming logic can examine the resulting class object to determine that meaning in a systematic way.

Engine

### Overview

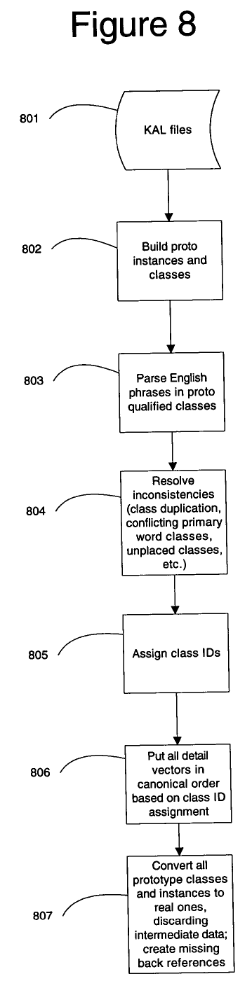

The PAM engine 216 control's PAM's execution, including the execution of PAM procedures 108 defined in the profile 202. After the profile has been loaded, as shown in FIG. 8 (discussed in more detail below), the engine identifies profile instances that are to be managed by PAM. In one embodiment, the criteria for management include: the existence of a suitable management procedure associated with the instance, its class, or a superclass of its class; the existence of details of the instance fulfilling requirements declared with the management procedure (generally known as “important details”); and the non-existence of details of the instance declaring that it should not be managed—in the preferred embodiment, a detail that is described as “not managed” will not be managed, nor will anything in its detail tree unless the declaration is overridden at a lower level. A detail can get its “important details,” typically with values, (a) from an instance model or model detail, (b) by interviewing the user, (c) by importing relevant information from the Web, or (d) by other means. A client is recognized by the fact that it is described as “client.”

The thing or things x represented by a detail d will start to be managed by the engine when the engine: (a) notices that x is ready to be managed; (b) creates a new detail m of d of class “management” to represent the ongoing activity (thread) of carrying out the applicable management procedure; (c) fill in details of m; and (d) schedules m on its calendar. The engine may notice and verify that x is ready to be managed in response to the creation and filling in of details of d, however that might have happened. Once the criteria are met, the engine will begin execution of the management procedure. As discussed elsewhere, these procedures are stored as part of the profile; in one embodiment, the steps of a procedure will be stored as details of the instance representing the procedure, with the classes of the steps defined such that their canonical ordering is the order in which the steps should be executed. In the preferred embodiment PAM procedures are interpreted directly by the PAM engine, but in other embodiments they are compiled into another form for faster execution.

The utility procedures 220 are used by the engine for external communication: obtaining user input, displaying data for the user, and communicating via networks such as the Internet with services that can provide information or services requested by a procedure. For example, a management procedure for a prescription might automatically renew the prescription by communicating with an Internet service provided by a pharmacy. Utility procedures manage that communication, including the translation of data into and out of the profile as needed, for example into a standard data transport format such as XML.

Management procedures should be as generic as possible. They should also typically be designed to be carried out by any competent agent, though, in some cases, they might be written to be carried out by a particular agent, say the system, or by some particular category of agent.

The system manages a thing in that it will, as an agent of a client, persistently and responsibly carry out the appropriate management activity. However, the system may not itself carry out all the individual tasks entailed by the management activity. A task that the system does not carry out (perhaps because PAM is not competent to carry out the task or perhaps because the system does not fully understand the task as expressed in English) will be delegated by the system to some other agent, such as:

a client or user;

a family member, friend, or colleague of a client or user;

some other PAM-resident agent (such as a web-access agent, a user interface agent, a purchasing agent, or a specialized problem-solving agent);

some software agent outside the PAM process; or

a robot.

When the system can identify more than one agent capable of performing a task (for example, when it can access two web services that can book airline reservations), it considers the following factors for each candidate agent:

competency;

time availability (prior to deadline);

availability of necessary resources to this agent (prior to deadline);

appropriateness of the assignment (within the scope of this agent's responsibilities and good use of this agent's time);

motivation (interest in and preference for such an assignment);

ability to accomplish the task within applicable constraints;

cost for this agent to carry out the task.

The system maintains at least a skeletal calendar for each agent to whom it might delegate tasks. At the time of delegation of a task, the system schedules appropriate actions for the chosen agent, as well as check-up and supervisory actions for itself. PAM also decides how much, if any, responsibility to delegate: in general, the less responsibility PAM delegates, the more closely it must supervise the chosen agent.

In carrying out management activities, the system uses common-sense reasoning operations for most non-trivial tasks.

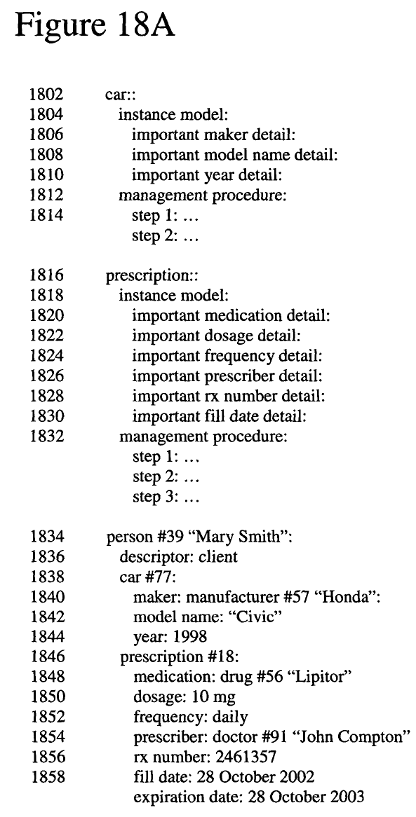

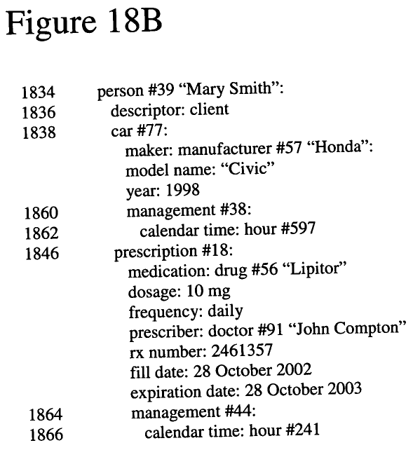

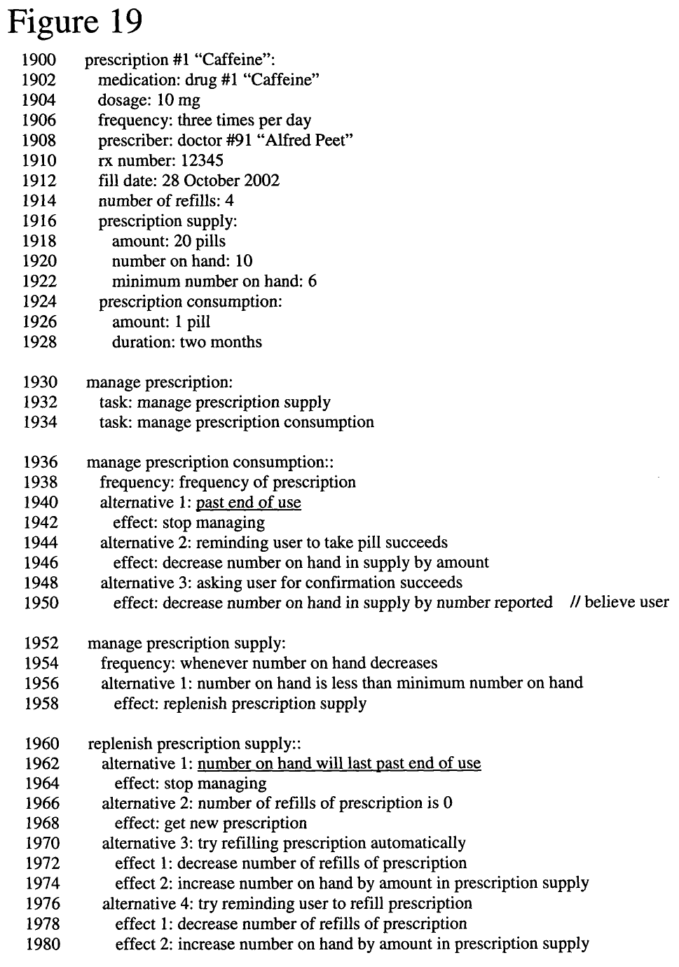

FIG. 18A shows some of the details associated with management in PAM. The class 1802, car, has an instance model detail 1804 that the engine of the preferred embodiment will use in deciding whether it can manage a particular car. The important details 1806-1810, if provided for a car instance, will allow that instance to be managed by the management procedure 1812 (see FIG. 19 for an example of a management procedure). Similarly the class 1816 prescription has an instance model detail 1818 with important details 1820-1830, and a management procedure 1832.

The person 1834 has a car 1838 and a prescription 1846; she is further described as a client 1836. The car has details 1840-1844 corresponding to the important details 1806-1810; the canonical ordering described elsewhere ensures that the details of the car corresponding to important details of the model instance will be in the same order as the important details in the model instance, as they are here. Similarly, the prescription 1846 has details 1848-1858 corresponding to the important details 1820-1830 of the prescription class's model instance. Since neither instance is described as “not managed,” and all important details have been filled in, the appropriate management procedure can be invoked for each.

The result is shown in FIG. 18B, where the car 1838 has a new management detail 1860, with a calendar time detail 1862. The calendar time detail here is, in the preferred embodiment, a back-reference from a calendar action detail (discussed above) on some calendar; this is the result of the management procedure's scheduling of an action on some calendar, which automatically added a back reference here. In a simple case, the calendar action would be on PAM's calendar, and would cause the client to be reminded on a specific date that it's time for an oil change, if she hasn't done one recently. Similarly, the calendar time 1866 for the prescription 1846 might typically correspond to a reminder to take the prescription at a specific time. As part of performing that action, the engine would, if requested, once again invoke the applicable management procedure to schedule further actions: taking the next dose, getting a refill, and so on.

FIG. 19 is an exemplary management procedure for a prescription 1900. As with the prescription 1846, it has all of the important details of the instance model 1818: medication 1902, dosage 1904, frequency 1906, prescriber 1908, rx number 1910, and fill date 1912. There are other details that will be used by the management procedure: number of refills 1914, prescription supply 1916, and prescription consumption 1924.

The management procedure itself is 1930. It has two task details 1932 and 1934; in the embodiment of this example, task details of a procedure cause new threads of execution to be spawned, to perform the actions specified. In this case, the task 1932 invokes the manage prescription supply procedure 1952, and task 1934 invokes the manage prescription consumption procedure 1936. That is, the basic logic of prescription management is to manage consumption, reminding the user to take his medicine, separately from supply, ensuring that the user has medicine to take.

The prescription consumption procedure 1936 has a frequency detail 1938, which the engine 216 can use to determine how often to cause the procedure to run—in this case, by matching the frequency detail 1906 of the prescription itself. In this embodiment, the value of the frequency detail 1938 will be a reference to the qualified class “frequency of prescription” rather than a reference to the frequency detail 1906; this allows the procedure 1936 to be used for many different prescriptions with different frequencies. The remaining details of this procedure are of class alternative. The engine will evaluate the value of each alternative in turn; the first one returning a success value will have its effect details performed, and the sequence of alternatives will end. Thus the alternative 1940 will be taken if the expression “past end of use” is true. This expression falls into the time domain of common sense reasoning: the prescription has a fill date 1912, and a duration 1928, from which the end of use can be computed; once we're past that time, the user should stop taking the medicine. The effect 1942, stop managing, will cause the prescription supply management task 1932 to terminate.

The other alternatives 1944 and 1948 remind the user to take the pill, or, failing that (the user didn't respond after some amount of time), ask the user whether he did. In either case, the effects 1946 and 1950 decrease the number of pills on hand, stored as the value of the detail 1920.

The prescription supply management procedure 1952 has two details. The frequency 1954 causes the procedure to execute when the number on hand detail 1920 decreases, as will happen when either of the effects 1946 and 1950 is executed. Again, note that the expressions in the procedure generally do not refer directly to instances: the “number on hand” in the expression 1954 is kept as a qualified class, and is resolved in internal data structures of the engine to the specific detail 1920 to be monitored. There is a single alternative 1956—if the number on hand is inadequate (in this case, is less than the value of the minimum number detail 1922), then the single effect 1958 will run, and the supply will be replenished by the procedure 1960.

The replenish prescription supply procedure 1960 is, again, a series of alternatives. First it applies common sense reasoning to see if the supply no longer need be worried about: if the number on hand will last (a simple calculation based on the frequency of consumption and the number on hand) past the end of use (also used in the alternative 1940), then, at effect 1964, stop managing. Thus a prescription with a limited duration will eventually have its management procedure terminate: the task 1932 will end when there's enough supply to last to the end of use, and the task 1934 will end, as described above, at the end of use. Once both tasks terminate, the management procedure 1930 will itself exit. The remaining three alternatives deal with refilling the prescription: 1966, if the number of refills is 0, indicates that a new prescription will be required; 1970 and 1976 try two methods of refilling the prescription. The “try” construction indicates that a possibly time-consuming task will be spun off in a new thread; when it either succeeds or fails, the engine will return this thread of execution from the “try,” and either perform the effects of the alternative, or move to the next one. Thus, if the prescription refill can be ordered via a web service, as in alternative 1970, the profile will be updated to reflect the increased supply; if not, at 1976, the user will be asked to get the prescription refilled. Once he has, the profile will be updated at 1978 and 1980.

KAL and KAP

The profile loading modules 218 contain software to manage external representations of the profile: reading and compiling it from various sources, saving it in its entirety, and maintaining a journal of changes to allow recovery from system failure.

In the preferred embodiment, the external representation is in a text format known as “KAL,” or Knowledge Assembly Language. Each class or instance detail that is represented in a KAL file is described on one line, possibly with marked continuation lines. Context/detail relationships are indicated by position in the file and indentation: the details of a particular instance will be directly after it in the file, indented one more level. FIG. 5a is a small exemplary profile in KAL format; at 505, the instance representing a dog named Fred is shown with three details, owner, color, and size, at a greater level of indentation. The person at 503, at the same level of indentation, is a detail of the same context as the dog.

In some embodiments, KAL includes directives to indicate that the profile is contained in several distinct computer files, and to control the order in which the files are processed during profile loading.

In aggregate, the detail lines in a KAL file set (a set of files holding a PAM profile in KAL format) constitute a detail outline corresponding to the profile detail tree. A detail d is represented in KAL as an indented detail line that:

for a class, has a representation of what the class corresponds to in English (or in qualified class notation—see below), followed by a double colon (::), such as the lines 600-648 in FIG. 5A; and

for an instance, has a representation of its class (what it corresponds to in English or in qualified class notation), followed by its instance ID if any prefixed by a number sign (#), optionally followed by a name of the instance, followed by a colon, followed by a representation of the value if any. See lines 503 and 508 in FIG. 5A for examples

Because classes may correspond to English phrases, KAP (the program that reads KAL files) must be able to parse English phrases to get them into semantically useful qualified class form. When KAP must deal with a word not known in the profile, it will attempt to morphologically decompose that word into an inflection of a word that is known, unless the word is hyphenated, in which case KAP will parse it as a phrase.

The following paragraphs specify the KAL representations used by the preferred embodiment. For real examples of KAL, see many of the figures attached., as well as appendix A.

A profile is represented in KAL as a single detail outline. In fact, any subtree of a profile can be represented in KAL as a detail outline. The detail outline of a large profile could have hundreds of thousands or even millions of lines, reflecting the detail tree (context tree) organization of the profile. Each detail line in the outline, beyond the first, basically represents a detail in its context, that context being represented by the nearest preceding detail line that is one outline level up. (Note that a detail line might actually have additional continuation lines if, for instance, it is “prettyprinted”.) Each line in the detail outline has an indentation proportional to its depth in the outline. A detail represented by an detail line beyond the first is said to be placed in (its) context.

The KAL representation of a number (an integer or a real) is just the normal sort of programming language representation of that number.

The KAL representation of a string is just the characters in the string enclosed in double quotes (“), except that double quote and backslash characters in the string need to be preceded by a backslash.

A “word spelling” can represent either a word class or, if decomposable morphologically or at hyphens, a qualified class. The KAL representation of a word spelling is just the sequence of characters in the spelling, except as follows. Characters other than letters (a to z and A to Z), digits (0 to 9), hyphens, apostrophes ('), and periods in the spelling need to be individually preceded by a backslash (\), except in the case of certain special single-character spellings (+, *, /, +, ?, !, ;, &, $, and %). Also, if the spelling looks like a number, at least one of the characters in the spelling needs to be preceded by a backslash. Note that it is okay for any printing character or any space in the spelling to be preceded by a backslash. Also note that the KAL representation of a word spelling is case-sensitive, reflecting the usual capitalization of the natural language word to which it typically corresponds.

The KAL representation of a class c is as follows. If c is a primary word class, then just the spelling of c. If c is a secondary word class, then the spelling of c, followed by an at-sign (@), followed by the KAL representation of the immediate superclass of c. The superclass may be any kind of class, including another secondary word class; if it's a qualified class, the phrase must be enclosed in brackets to allow parsing. If c is a qualified class (the only other possible case), then its representation is as described below.

A “phrase” in KAL is a sequence of two or more phrase elements that represent an English phrase or a mathematical or programming language expression. A “phrase element” can be:

a number,

a string,

a word spelling,

a KAL representation of a secondary word class,

a KAL representation of a list (see below),

a KAL representation of a qualified class in qualified class notation (see below), or

a bracketed subphrase (with one or more elements in this special case) of the form phr. [subphrase-element-1 . . . ], which is “pseudo qualified class notation” used to guide parsing.

Besides the bracketing construct, another way to guide parsing is to hyphenate the words of the subphrase (as in, say, “hard-to-understand concept”); when hyphenation of this kind is possible, it is preferred. The preferred embodiment does not permit phrases that end with a string, to avoid ambiguity, or the appearance of ambiguity, in KAL.

The “qualified class notation” for a qualified class is of the form

head-word-class [qualifier-role-1: qualifier-1, qualifier-role-2: qualifier-2, . . . ]

where head-word-class is the KAL representation of the head word class, where qualifier-role-i is the KAL representation of the qualifier role class but can be omitted if it can be easily derived from the head word class and corresponding qualifier, where qualifier-i is the KAL representation of the qualifier as a value, and where the order of qualifiers is innermost to outermost. The class “big black dog” of FIG. 5E can also be represented in KAL with this notation as “dog [color:black, size:big].”

The KAL representation of a qualified class c is one of the following: a word spelling with hypens, prefixes, and/or suffixes; a phrase corresponding to c; or qualified class notation for c.

The KAL representation of an instance s begins with the KAL representation of the class of s. Following this, if s has an instance ID (there must be one unless s is here being placed in context), a space followed by the instance ID prefixed by a number sign (#). Following this, if s has a name, then a space followed by the name enclosed in double-quotes (“), for better human identification of s. Item 505 is an example of this.

The KAL representation of a value v is as follows. If v is a number, string, class, or instance, then the KAL representation of v, as above. If v is a list, then KAL representations of each of the elements separated by commas and enclosed in parentheses; immediately following the colon at the “top level” of a detail line, the parentheses may be omitted. Items 501, 508, 516, and 1720 show examples of this.

A KAL representation of a PAM profile subtree with root d is as follows:

1. Indentation to a certain level l.

2. The KAL representation of d, as above.

3. If d is a class, then a double colon (::). If d is an instance, then a colon (:) followed, if d has a value v, by a space followed by the KAL representation of v, as above.

4. If d has one or more details, KAL representations, recursively, for each of those details in their canonical order (but see below for possible elisions of ordinal and proper name details), each starting on a new line with indentation to level l+1.

As described above, the KAL representation of a profile sub-tree is a detail outline, where there is one line for each detail in the sub-tree and where lines for details of a detail d follow the line for d and are indented one more level. Note, however, that a detail line for a name detail can be omitted if it has no details and is in effect specified in the detail line for its context.

Whenever a KAL representation of a detail is used in KAL, i.e., whenever a detail is referred to in KAL, KAP will either locate that detail or create it if it does not yet exist. A KAL representation of a qualified class or a secondary word classes either specifies or implies its context, and therefore it is not necessary (nor is it recommended) to place it in context unless it has one or more details that themselves need to be placed in context. Instances and primary word classes, however, need to be placed in context to avoid warnings and default context assignments (see below).

In KAL representations, note that one or more spaces must be used to separate successive numbers, word spellings (except for the special single-character spellings), strings, or combinations of these. Note further that any number of spaces or extra spaces may generally be used between successive KAL tokens (numbers, word spellings, strings, parentheses, brackets, commas, colons, at-signs, etc.).

Beyond this, some embodiments provide notational conventions for:

including line numbers, continuation heads, and an alphabetized ID of details, to improve the ability of humans to locate and understand particular details;

formatting times more naturally;

prettyprinting values;

indicating a continuation line, say by a vertical bar (|) as the first printing character of the line;

including comments and warnings of various kinds, enclosed in curly brackets;

including a header with title, date, source, and preference information.

### KAP: Loading and Saving PAM Profiles

A profile is maintained “externally” in KAL format in a KAL file set. KAL file sets may serve as source code for and/or as saved versions of the profile. A KAL file set for a source code and/or saved version of a profile is a single large detail outline, as described above.

Profile loading is accomplished by a module shown in FIG. 2 as “KAP,” Knowledge Assembly Program. It depends in turn on the “KAL Parser” module, which can take a line in KAL format and convert it to a data structure derived from the instance and class structures shown in FIG. 4. As shown in FIG. 5a, KAL format includes relatively simple punctuation elements used to guide the KAL parser; in addition, it contains class names for both word and qualified classes. Qualified classes, in the preferred embodiment, are often represented in KAL as phrases in a natural language such as English; the KAL parser therefore includes the ability to parse such phrases into their representation as qualified classes. The result is shown in FIGS. 5c and 5d for the phrase “black dog,” where item 560 is the structure representing the qualified class, explained elsewhere.

In the preferred embodiment, KAP is a multi-pass procedure, as shown in the flowchart in FIG. 8. The first pass 802 constructs a prototype profile from the KAL format input files 801. Because the KAL files, as shown in FIG. 5a, include all class definitions as well as instance data, and because they are in a form that can be manually edited, the first pass does not resolve inconsistencies, and cannot attempt to parse English phrases found in the KAL—the data needed to do so has very likely not been seen yet. At the end of this pass, KAP can place any unplaced primary word classes; the preferred embodiment makes them subclasses of a distinguished class, “unplaced word.”

The second pass 803 uses data in the prototype profile to parse English phrases into qualified classes—all word classes were found and identified during the first pass, so the parser in 803 can determine parts of speech, and will know whether a word has been defined or not. Once all the English phrases have been parsed, in 804 the KAL parser resolves inconsistencies that might have been revealed.

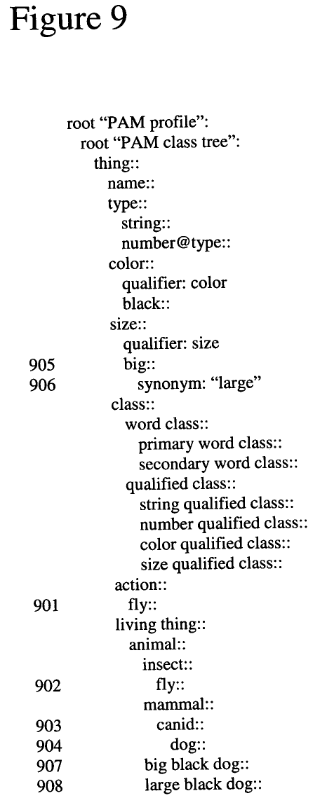

Examples of inconsistencies that might need to be resolve are shown in FIG. 9, a small exemplary profile in KAL format. Items 901 and 902 show two primary word classes named “fly,” one a subclass of action, the other a subclass of insect. By definition, there can only be one primary word class with a given name, so KAP must convert one or both of these classes to secondary word classes, whose names will include the name of the superclass.

Item 907 is an explicit definition of the class “big black dog.” However, it is placed as a subclass of animal, rather than as a subclass of dog. When KAP has parsed the phrase, it will identify the head word class as dog; the head word class must be a superclass, direct or indirect, of a qualified class, so KAP must change the class's placement so that it's a subclass of dog.

At the end of the loading/assembly process, KAP ensures that the following things have happened::

step 804 provides default context placements for instances that have been referred to in values but have not been placed in context, making them details of unplaced-instances details of their respective classes;

step 807 fills in missing back references;

step 805 does a numbering of the classes, ensuring canonical order for all class details in the class tree;

step 807 fills in, for each class c, the largest possible class ID of c or any subclass of c per the current class numbering, as well as other related information (see above);

step 806 canonically orders (using a “stable” sort) vectors of details insofar as they are not already canonically ordered;

step 807 sets various “static class variables” (in .NET parlance) to refer to certain details.

In preparing KAL source code, a developer should ensure that there is a detail line placing each primary word class and each instance that is referred to in a KAL file set, to provide its context and avoid a warning and default context placement (see below). However, the KAL representation of a qualified class or a secondary word class either specifies or implies its context, and therefore it is not necessary (nor is it recommended) for there to be a detail line placing it in context unless it has one or more details that need detail lines for their placement in context or unless a developer wishes to have all classes shown, appropriately placed in the detail outline.

KAL files may, with adequate caution, be edited by developers. For example, from time to time, a developer might move some details from default contexts to meaningful contexts and delete other such details. (Saved versions of profiles that have not had subsequent hand editing should have details in canonical order, and should thus require minimal if any resorting of details upon loading.)

Various preferences can be expressed relative to profile saving: whether or not to save details of the unplaced-word and unplaced-instances default contexts; whether or not to include detail lines for those qualified classes and secondary word classes that have no details needing to be included (see above); whether to represent qualified classes as phrases or in qualified class notation; whether or not to include names for instances enclosed in double-quotes (”); whether or not to include line numbers and an alphabetized index of details; whether or not to include continuation heads; whether or not to “prettyprint” values; which kinds of comments to include in curly brackets; etc.

Standard source code control tools may be used to do comparisons of different KAL versions of a profile, with good results even when they are saved versions (as opposed to hand-edited versions) of the profile.

### KAL Plug-Ins

A KAL plug-in is a KAL file set that, when loaded into a profile, adds any number of detail trees to the profile. For each such detail tree, a context for the root must be specified, presumably one that already exists in the profile. Word classes added (placed in the context of its immediate superclass) by the plug-in should be added ahead of any references, so that KAL representation conflicts between the existing profile and the plug-in can be properly resolved.

### KAL Phrase Parsing

A “known phrase” is a KAL or English phrase, the parse for which is already represented (as a qualified class) in the profile. An “idiom” is a known phrase whose meaning cannot readily be inferred from its component elements: a “black dog” is just a dog whose color is black, but the meaning of “yellow dog contract” has nothing to do with dogs of any color. As discussed above, KAP tries to parse shorter phrases first, precisely because the parsing of longer phrases may depend, in part, on phrases becoming known through the parsing of shorter phrases.

When a KAL phrase is parsed, a qualified class is produced, as illustrated in FIG. 5.

In one respect, the order of qualifiers in a qualified class doesn't matter. Common sense reasoning operations should ordinarily find a qualifier of interest wherever in the series of qualifiers it might occur. But in another respect, the order does matter. If a KAL or English phrase includes a known phrase as a subphrase, its parse (a qualified class) should include the parse of that known phrase; to do this efficiently and naturally, it is useful for there to be an appropriate and standard ordering of the qualifiers. (In the example discussed above, the parse of “very few big black dogs in the neighborhood” would include the parse of “black dog”, which could well be a known phrase represented by a qualified class with details.) Also, the order of qualifiers in a qualified class can affect the canonical order of details. In general, it is more operationally efficient for things to be in a standard order.

Computerized Common Sense Reasoning Logic

### Overview

Generally, common-sense reasoning (CSR) is a way of saying, “the simple inferences people make on a daily basis that they don't have to think about.” These involve questions about location, time, amounts, names, language, and so on. For example, consider the following:

The dry cleaner is close to the supermarket, so I might as well make one trip to pick up dinner and drop off my suit.

When I'm in San Francisco, I need to call Boston at 5:30 to talk to my daughter before she goes to bed at 8:45.

Although some cars have three wheels, a typical car will have four, so when I'm pricing a new set of tires I can assume, in the absence of other information, that that's how many I'll need.

Preferred embodiments of the invention try to emulate the particular kinds of common-sense reasoning that people can typically explain in English. In fact, the systematized common-sense reasoning is based on English.

Preferred embodiments organize common-sense reasoning by domain. The major common-sense reasoning domains are:

1. time,

2. location,

3. amounts,

4. names,

5. classes,

6. language,

7. actions,

8. objects,

9. relations, and

10. logic.

Each common-sense reasoning domain is associated with certain classes of details and with formal conventions for representing intensions of English constructions in terms of details, values, and detail trees. A value of a detail associated with a particular reasoning domain typically needs to be interpreted according to the class of that detail. Some classes allow values that require sophisticated reasoning algorithms to interpret and make use of. Inverse relations are important in all the major reasoning domains.

Each domain has various (about five to ten) reasoning problems. Representative sets are shown in the following tables (These sets may be made larger, but the set below is chosen for illustrative purposes).

| Time | Location | Amount | Name | Class |
|---|---|---|---|---|
| inferring time | inferring | inferring | inferring | inferring |
| evaluation | location | amount | names | class |
| order of | evaluation | evaluation | evaluation | evaluation |
| occurrence | containment | unit | synonyms | class |
| duration | proximity | conversion | variant | membership |
| time/date | distance | estimation | spellings | automatic |
| format | routing | comparison | misspellings | class |
| conversion | relative | arithmetic | homonyms | formation |
| time zones | position | | aliases | qualified |
| local time | normal | | partial | class |
| start time | location | | names | interpreta- |
| time overlap | | | names of | tion |
| scheduling | | | persons | |
| Language | Actions | Objects | Relations | Logic |
| parsing | procedure | prototypical | inferring | truth |
| grammaticality | execution | and typical | relation | inclusion |
| word | primitive | instances | evaluation | singular/ |
| morphology | action | possession | associativity | plural |
| intension | execution | parts | family | |
| interpretation | agency/ | state | relations | |
| generation | responsi- | | | |
| rephrasing | bility | | | |
| | currency | | | |
| | recurrence | | | |
| | contingency | | | |
| | consequence | | | |
| | planning | | | |

In the table, “evaluation” means determining a more-or-less context-independent value for a detail. “Yesterday” is context-dependent, while “Feb. 9, 2003” is not; “two doors down from my office” is context-dependent, while “Room NE43-257 at MIT” is not.

For each reasoning problem, there is a set of operations that do reasoning to help deal with the problem. Such reasoning is typically done by algorithms; some embodiments may choose to make the algorithms use definitions and axioms stored in the profile, for increased generality, rather than building everything into code in the algorithm. Thus, in FIG. 7, a daughter 728 is in effect defined as a child that is female; reasoning would use this definition to apply what it can do with the concept “child” to someone who was described instead as a “daughter.” Similarly, some time reasoning algorithms might need to know how to deal with time zones, but those can all defined as a time offset in minutes from UTC—as with the definition of “daughter,” this expresses the concept in terms of more primitive things, thus extending the range of reasoning that can be done.

Instance models, typical instances, and examples (kept as details of classes), discussed above, are important for common-sense reasoning in the class domain. As described above, a typical instance of a class can provide information that in other systems might be managed implicitly as default values for particular fields. But more generally, a “typical day” or a “typical work day,” for example, contains information supplied by the user that permits time reasoning logic to make educated guesses about what times are truly free, without cluttering the user's calendar with events that happen every day.

For most applications, the time domain is expected to be one of the most important common-sense reasoning domains. As discussed above, a “time” is a class corresponding to an English word, number, or phrase that represents a time. Time details often have times as values, and the time domain common-sense reasoner reasons with times. Times as expressed in English can range from a numerical representation of the number of seconds since some known event to complex English statements—“three weeks before my brother's next wedding.” Many such expressions require considerable reasoning to evaluate, depending as they do on knowledge about other events, and relationships among them.

The calendar structure discussed above is a specialized kind of detail tree used by scheduling operations in the time domain. This structure allows efficient storage and retrieval of events based on their time, for calendars of widely varying sizes. The efficiency of the structure, the presence in the system of many different calendars (such as the user's calendar, calendars for specialized software agents, and calendars for other people and groups), and the concept of typical schedules all support reasoning about time.

It will be appreciated that the preferred embodiment may be implemented on various processing platforms assuming such platform has sufficient memory and processing capacity. The logic may be distributed in various forms with different divisions of client and server technology or may be unitary. Likewise front-end or presentation components may be substituted or modified to operate with the embodiments, for example, the inclusion of speech recognition or the like.

It will be further appreciated that the scope of the present invention is not limited to the above-described embodiments, but rather is defined by the appended claims (which follow Appendix A), and that these claims will encompass modifications of and improvements to what has been described.

```
APPENDIX A
root “PAM-class-tree”:
  thing::
    negation::
      not::
      never::
      non-::
      un-::
      minus::
    name::
      synonym::
      antonym::
      homonym::
      word::
        preposition::
          in::
        determiner::
          a::
            synonym: “an”
        adjective::
        unplaced-word::
        variant@word::
          British variant@word::
        plural word::
      first name::
      middle name::
      last name::
      proper name::
    symbol::
      character::
        letter::
          a@letter::
          b@letter::
          ...
          capital letter::
            A@letter::
            B@letter::
            ...
        digit::
          zero digit::
          one digit::
          ...
        &::
          synonym: “ampersand”
        sign@character::
          +::
            synonym: plus sign@character
          $::
            synonym: dollar sign@character
    kind::
      class::
        word class::
          primary word class::
          secondary word class::
        qualified class::
          size qualified class::
          weight qualified class::
          color qualified class::
      type::
      category::
        fauna::
        flora::
          grass::
          moss::
          mold::
      sort@kind::
    quantity::
      number::
        zero::
          synonym: 0
        one::
          synonym: 1
        two::
          synonym: 2
        ...
        ten::
          synonym: 10
        eleven::
          synonym: 11
        twelve::
          synonym: 12
        thirteen::
          synonym: 13
        ...
        twenty::
          synonym: 20
        thirty::
          synonym: 30
        ...
        hundred::
          synonym: 100
        thousand::
          synonym: 1000
        million::
          synonym: 1000000
        billion::
          synonym: 1000000000
        trillion::
          synonym: 1000000000000
        ...
      multiplier::
        prefix multiplier::
          pico-::
            factor: .000000000001
          nano-::
            factor: .000000001
          micro-::
            factor: .00000 1
          milli-::
            factor: .001
          centi-::
            factor: .01
          deci-::
            factor: .1
          kilo-::
            factor: 1000
          mega-::
            factor: 1000000
          giga-::
            factor: 1000000000
      amount::
        unit-of-measure::
          weight unit-of-measure::
            gram::
            ounce::
            pound::
            ton::
          distance unit-of-measure::
            meter::
            micron::
            mil::
            inch::
            foot::
            yard::
            mile::
        piece::
        -ful::
    ordinal::
      nth::
        first::
          synonym: number 1
        second::
          synonym: number 2
          second from last::
        third::
          synonym: number 3
          third from last::
        ...
      middle::
      last::
    aggregation::
      group::
      set::
      bunch::
      flock::
        gaggle::
      herd::
    element::
      member::
    time::
      year::
        ...
        year 2001::
        year 2002::
        year 2003::
        ...
      month::
        January::
          synonym: month 1
        February::
          synonym: month 2
        ...
      day::
        Sunday::
        Monday::
        ...
        day 1::
        day 2::
        ...
      midnight::
      am::
        0.5 am::
        1 am::
        1.5 am::
        2 am::
        ...
      noon::
      pm::
      hour::
      minute::
      second::
      GMT::
      standard time::
      daylight savings time::
      calendar time::
    place::
    state::
      -ness::
    organization::
      company::
        corporation::
    action::
      synonym: “do”
      seem::
      sense::
      create::
      move::
        transport::
      calendar action::
    object::
      container::
        box::
        cup::
      vehicle::
        car::
            synonym: “automobile”
        person::
        animal::
        plant::
        furniture::
          descriptor: non-discrete
          table::
          chair::
      substance::
        liquid::
          water::
            fresh water::
            sea water::
          wine::
          beer::
          liquor::
          juice::
          milk::
          soda::
        gas::
          air::
          hydrogen gas::
        solid substance::
          wood::
          fabric::
            cotton::
            wool::
          metal::
            steel::
          plastic::
        element@substance::
          atomic element@substance::
            hydrogen::
            oxygen::
        chemical::
      property::
        size::
        weight::
        distance::
          length::
          height::
          width::
          depth::
        gender::
        synonym: “sex”
        male::
          adjective: “masculine”
        female::
          adjective: “feminine”
      color::
        black::
          ebony@black::
          midnight black::
        white::
          pearl white::
        red::
          crimson::
        blue::
          azure::
        green::
        yellow::
        orange::
        purple::
        brown::
        gray::
          variant@word:: “grey”
          charcoal@gray::
  pink::
```

What is claimed is:

1. A computer-readable medium having computer instructions for storing and managing a knowledge profile,
wherein knowledge is stored in knowledge units representative of unconstrained natural language (NL);
wherein any given knowledge unit is associatable with at least one other knowledge unit with the given knowledge unit being a context knowledge unit, and the at least one other knowledge unit being a detail knowledge unit of the associated context knowledge unit, and such that every given context knowledge unit that has at least one associated detail knowledge unit satisfies a NL relationship there-between that corresponds to one of the NL-expressible forms of the NL word “have”;
wherein the profile includes a core set of knowledge units for a core vocabulary of words, at least some of which are associated with knowledge units to provide a basic meaning of the associated words;
wherein the profile further includes a core set of knowledge units for core processing and core parsing NL-expressible knowledge;
wherein the knowledge units are arranged in accordance with a predefined structure that reflects context-detail relationships and that is dynamically extensible to include other knowledge units during run-time; and
wherein the placement and relationships of knowledge units within the predefined structure further reflect semantic interpretations of the knowledge units and support algorithmic reasoning about the knowledge in the profile.

2. The computer-readable medium of claim 1, wherein the profile includes NL class structures to form knowledge units to represent NL words and phrases.

3. The computer-readable medium of claim 2, wherein the profile includes NL word class structures to form knowledge units to represent NL words.

4. The computer-readable medium of claim 3, wherein NL word class structures have associated values, and wherein the associated values of the word class structures are spellings of the word corresponding to the NL word class structure.

5. The computer-readable medium of claim 3 wherein the word class structures include primary word class structures to represent a word with an associated spelling.

6. The computer-readable medium of claim 3 wherein some word class structures specify an immediate superclass of the word represented by the word class structure to distinguish said word from any other words having an identical spelling to said word.

7. The computer-readable medium of claim 2, wherein the profile includes qualified word class structures to form knowledge units to represent NL phrases.

8. The computer-readable medium of claim 7, wherein qualified word class structures include information to represent word forms, including irregular word forms.

9. The computer-readable medium of claim 2, wherein, to form knowledge units to represent NL phrases, the profile includes qualified word class structures and NL word class structures, and wherein a NL word class is used to represent a head word of the NL phrase and wherein qualified word class structures are used to represent a series of qualifiers of the head word in accordance with the NL phrase expression of the qualifiers.

10. The computer-readable medium of claim 9 wherein the NL word class structure for a head word is identifiable based on its positional relationship within the predefined structure in relation to the qualified word class structures and based on it being a NL word class structure.

11. The computer-readable medium of claim 9, wherein the knowledge units to represent NL phrases include qualifier class structures to represent a role of the qualifiers of the qualified word class.

12. The computer-readable medium of claim 11 wherein the role is represented by a NL word class structure and wherein a set of class structures to represent roles includes the following roles or semantic equivalents thereof: structure, string, number, quantity, determiner, tense and type.

13. The computer-readable medium of claim 11 wherein the combination of the role and the NL word class used to represent a head word represent semantics of the NL phrase.

14. The computer-readable medium of claim 9 wherein the qualified word class structures may be chained to represent arbitrary NL phrases.

15. The computer-readable medium of claim 1, wherein the predefined structure is a tree structure.

16. The computer-readable medium of claim 15 wherein the core set of knowledge units for a core vocabulary of words is organized within a sub-tree of the profile tree.

17. The computer-readable medium of claim 1 wherein the profile includes structures with a predefined structural definition and wherein detail knowledge units are formed from said structural definition and context knowledge units are formed from said structural definition, and wherein the structural definition includes information for identifying a structure to represent an associated context.

18. The computer-readable medium of claim 2 wherein the profile includes structures with a predefined structural definition and wherein detail knowledge units are formed from said structural definition and context knowledge units are formed from said structural definition, and wherein the structural definition includes information for identifying a structure to represent an associated context and wherein the structural definition includes information for identifying an associated NL class structure.

19. The computer-readable medium of claim 18 wherein the structural definition includes information for identifying associated detail structures.

20. The computer-readable medium of claim 19 wherein the information identifying associated detail structures identifies the detail structures in a canonical ordering.

21. The computer-readable medium of claim 20 wherein the identified associated detail structures each have an associated class structure and wherein the class structures have a class ID and wherein the canonical ordering is based on the class ID.

22. The computer-readable medium of claim 18 wherein the structural definition includes information for a value to specify the detail structure.

23. The computer-readable medium of claim 22 wherein the structural definition is used to form NL word class structures and wherein the value of NL word class structures is a spelling of an NL word represented by the NL class structure.

24. The computer-readable medium of claim 2 wherein the profile includes detail structures to represent instances associated with a corresponding class structure and wherein the class structure represents a kind of thing the detail represents an instance of.

25. The computer-readable medium of claim 24 wherein at least some detail structures to represent instances include associated value information, and wherein said value information is context independent meaning of the corresponding detail.

26. The computer-readable medium of claim 24 wherein specifications of class structures are substantially static, and wherein specifications of instances are modifiable.

27. The computer-readable medium of claim 26 wherein class structures specifications permit downcasting of class.

28. The computer-readable medium of claim 9 wherein the computer-readable medium includes logic to transform a knowledge unit that represents a NL phrase and comprised of a class structure for a head word and qualified class structures for a series of associated qualifiers of the head word into a semantically equivalent knowledge unit comprised of a detail structure that represents an instance of the head word NL class structure wherein said instance is specified by associated details with semantic equivalence of the associated qualifiers.

29. The computer-readable medium of claim 9 wherein the computer-readable medium includes logic to transform a detail structure that represents an instance of a head word NL class structure, wherein said instance is specified by associated details, into a semantically equivalent knowledge unit that represents a NL phrase and comprised of a class structure for a head word of the phrase and qualified class structures for a series of associated qualifiers of the head word with semantic equivalence of the associated details of the instance.

30. The computer-readable medium of claim 28 wherein the logic to transform algorithmically determines the details to specify the instance by processing the qualified word classes for the series of qualifiers of the head word.

31. The computer-readable medium of claim 1 wherein the profile is organized in accordance with predetermined rules and wherein a context knowledge unit includes a specification of detail knowledge units associated therewith and wherein the specification of detail knowledge units is canonically ordered in accordance with the predetermined rules.

32. The computer-readable medium of claim 24 wherein NL class structures are arranged in accordance with a specified class hierarchy having NL subclasses and NL superclasses, and wherein each NL class has an associated class ID, and wherein class structures are assigned class IDs in accordance with the predetermined rules, and wherein the NL class structures of the profile are canonically ordered

33. The computer-readable medium of claim 31 wherein the NL class structures include information for identifying an extent of subclasses related to the NL class represented by the NL class structure, and wherein the medium includes logic to test whether an identified NL class is a subclass of another identified NL class by comparing the class ID of the identified NL class to the extent identifying information of the other identified NL class.

34. The computer-readable medium of claim 2
wherein each class structure of a specified set of NL class structures corresponding to invertible NL relationships has an inverse relation detail specified by a class structure representing the inverse relation; and
wherein the medium includes logic that detects if an instance detail is being specified with a relationship detail, the relation for which is in the specified set, and that automatically creates an inverse relationship detail for the instance corresponding to the relationship detail, the inverse relationship detail specifying the context detail.

35. The computer-readable medium of claim 34 wherein the medium includes logic for monitoring relationship details and automatically manages said details and corresponding inverse relation details in response to changes of either.

36. The computer-readable medium of claim 2 wherein NL class structures have an associated knowledge unit specifying details of a typical instance of a NL class represented by the NL class structure, whereby detail structures of the profile may reference one of said NL class structures with an associated typical instance, and whereby reasoning logic may infer knowledge about the instance by considering the details specified by the typical instance details.

37. The computer-readable medium of claim 2 wherein NL class structures have an associated knowledge unit specifying details of a model instance of a NL class represented by the NL class structure, and wherein a model instance specifies important details as being necessary for automated management of any instances of the NL class.

38. The computer-readable medium of claim 37 further including logic to automatically manage instances that have specifications for important details.

39. The computer-readable medium of claim 37 further including logic to delegate management of a knowledge unit to an agent.

40. The computer-readable medium of claim 1 further including logic to export the knowledge units to a text file such that the text file has an outlined presentation preserving the associations between context knowledge units and detail knowledge units in a hierarchical form.

41. The computer-readable medium of claim 1 further including logic to import knowledge from a text file that has an outlined presentation in predefined form and that represents associations between context knowledge and detail knowledge in a hierarchical form, wherein the logic to import creates knowledge units for the context knowledge and the detail knowledge and creates associations between such created knowledge units to preserve the associations represented in the text file.

42. The computer-readable medium of claim 1 wherein the knowledge units include descriptor details that are details of a class “descriptor” and wherein the descriptor details correspond to NL adjectives, NL adjective with an adverbial modifier, a generic NL noun, a generic NL compound noun, a generic NL prepositional phrase, or a generic NL verb phrase.

43. A system for storing and managing a knowledge profile, comprising:
a processing platform with processing and storage resources;
wherein knowledge is stored in the storage resources as knowledge units representative of unconstrained natural language (NL);
wherein any given knowledge unit is associatable with at least one other knowledge unit with the given knowledge unit being a context knowledge unit, and the at least one other knowledge unit being a detail knowledge unit of the associated context knowledge unit, and such that every given context knowledge unit that has at least one associated detail knowledge unit satisfies a NL relationship there-between that corresponds to one of the NL-expressible forms of the NL word “have”;
wherein the profile is stored in the storage resources and includes a core set of knowledge units for a core vocabulary of words, at least some of which are associated with knowledge units to provide a basic meaning of the associated words;
wherein the profile further includes a core set of knowledge units for core processing and core parsing NL-expressible knowledge;
wherein the knowledge units are arranged in accordance with a predefined structure that reflects context-detail relationships and that is dynamically extensible to include other knowledge units during run-time; and
wherein the placement and relationships of knowledge units within the predefined structure further reflect semantic interpretations of the knowledge units and support algorithmic reasoning about the knowledge in the profile.

44. A computer-implemented method of storing and managing a knowledge profile, comprising:
storing knowledge as knowledge units representative of unconstrained natural language (NL);
wherein any given knowledge unit is associatable with at least one other knowledge unit with the given knowledge unit being a context knowledge unit, and the at least one other knowledge unit being a detail knowledge unit of the associated context knowledge unit, and such that every given context knowledge unit that has at least one associated detail knowledge unit satisfies a NL relationship there-between that corresponds to one of the NL-expressible forms of the NL word “have”;
wherein the profile includes a core set of knowledge units for a core vocabulary of words, at least some of which are associated with knowledge units to provide a basic meaning of the associated words;
wherein the profile further includes a core set of knowledge units for core processing and core parsing NL-expressible knowledge;
arranging the knowledge units in accordance with a predefined structure that reflects context-detail relationships and that is dynamically extensible to include other knowledge units during run-time; and
wherein the placement and relationships of knowledge units within the predefined structure further reflect semantic interpretations of the knowledge units and support algorithmic reasoning about the knowledge in the profile.
